(19) United States
(12) Patent Application Publication
(10) Pub. No.: US 2015/0346969 A1
(43) Pub. Date: Dec. 3, 2015

(54) INTERACTIVE MEDIA OBJECT DEVELOPMENT SYSTEM AND METHOD

(71) Applicant: Rowan Technology Solutions, LLC, New York, NY (US)

(72) Inventors: Timothy R. Strabbing, New York, NY (US); Anthony J. Manganiello, Pen Argyl, PA (US); Christopher A. Kingsley, Lincoln, NE (US); Jacklyn D. Miller, Lincoln, NE (US); Jay P. Knapp, Lincoln, NE (US); Ross T. Harrison, Lincoln, NE (US); Adam C. Templeton, Lincoln, NE (US); Nicholas T. Franken, Lincoln, NE (US); Paul J. Klopping, Lincoln, NE (US)

(73) Assignee: Rowan Technology Solutions, LLC, New York, NY (US)

(21) Appl. No.: 14/292,172

(22) Filed: May 30, 2014

(51) Int. Cl. G06F 3/0484; G06T 19/20

(52) U.S. Cl. CPC G06F 3/04845; G06T 19/20; G06T 2213/08

(57) ABSTRACT

Systems and methods are described herein that enable a user (e.g., a developer) to develop an interactive media object. The interactive media object may be suitable for embedding in a digital book, a web page, or other application. A user may be provided with a graphical user interface that enables a user to add one or more components to the interactive media object. For example, a user may be enabled to provide a background image. The user may be further enabled to insert a foreground image and/or one or more overlay(s) (i.e., an image that can be toggled on or off by the user) over the background image. The user may further be able to insert “hotspots” and/or filmstrips over the background image, foreground image, and/or the overlay(s). A bundler may be provided that assembles the one or more components into the interactive media object.

### BACKGROUND OF THE INVENTION

1. Field of the Invention

The present invention relates to systems and methods for developing interactive media objects.

2. Background

Advances in digital publishing technology have enabled publishers to produce content for consumption by end users in formats that are new, innovative and exciting. For example, digital books (or “e-books”) can be downloaded to an end user's e-reader, tablet computer, or mobile phone and read thereon. Such digital books may include components that at first blush look like static illustrations, but are actually fully interactive media objects. A user can interact with such interactive media objects, for example, to cause such objects to dynamically change and/or present additional content in the form of text, pictures, audio and/or video. One example of a type of interactive media object is an HTML widget that can be included in an iBook® suitable for viewing using the iBooks® application published by Apple Inc. of Cupertino, Calif. However, other types of interactive media objects exist and can be inserted in digital books, web pages, or other digital publications to facilitate user interaction therewith.

Existing tools for developing interactive media objects, which may range from simple text editors to more advanced Web content creation applications, are quite limited in terms of their functionality. For example, such tools generally do not provide a developer with a way to easily generate, select and combine the data, code and media assets that taken together make up an interactive media object.

### BRIEF SUMMARY OF THE INVENTION

Systems, methods and computer program products are described herein for, among other things, enabling a user to develop an interactive media object suitable for display on a computing device.

In particular, a method for enabling a user to develop an interactive media object suitable for display on a computing device described herein. In accordance with the method, a graphical user interface is provided by which the user can select a background image and one or more interactive components for insertion over the background image. The interactive component(s) include at least one of a hotspot that causes multimedia content to be displayed over the background image when activated, an overlay component that causes an image to be displayed over the background image when activated and causes the image to be hidden when deactivated, a foreground image that is displayed over the background image, and a filmstrip that is displayed over the background image and that comprises a set of images that compose an animation when played back. A bundler is also provided that assembles the background image and the one or more interactive components into the interactive media object.

A system is also described herein. The system includes one or more processors and a memory. The memory stores computer program logic that, when executed by the processor(s), enables a user to develop an interactive media object suitable for display on a computing device. The computer program logic, when executed by the processor(s), performs the step of providing a graphical user interface by which the user can select a background image and one or more interactive components for insertion over the background image. The interactive component(s) include at least one of a hotspot that causes multimedia content to be displayed over the background image when activated, an overlay component that causes an image to be displayed over the background image when activated and causes the image to be hidden when deactivated, a foreground image that is displayed over the background image, and a filmstrip that is displayed over the background image and that comprises a set of images that compose an animation when played back. The computer program logic, when executed by the processor(s), also performs the step of providing a bundler that assembles the background image and the one or more interactive components into the interactive media object.

A computer program product is also described herein. The computer program product includes a computer-readable medium having computer program logic recorded thereon for enabling a processor-based system to enable a user to develop an interactive media object suitable for display on a computing device. The computer program product includes a first program logic module for enabling the processor-based system to provide a graphical user interface by which the user can select a background image and one or more interactive components for insertion over the background image. The interactive component(s) include at least one of a hotspot that causes multimedia content to be displayed over the background image when activated, an overlay component that causes an image to be displayed over the background image when activated and causes the image to be hidden when deactivated, a foreground image that is displayed over the background image, and a filmstrip that is displayed over the background image and that comprises a set of images that compose an animation when played back. The computer program product further includes a second program logic module for enabling the processor-based system to provide a bundler that assembles the background image and the one or more interactive components into the interactive media object.

An apparatus is also described herein. The apparatus includes a first means for providing a graphical user interface by which the user can select a background image and one or more interactive components for insertion over the background image. The interactive component(s) include at least one of a hotspot that causes multimedia content to be displayed over the background image when activated, an overlay component that causes an image to be displayed over the background image when activated and causes the image to be hidden when deactivated, a foreground image that is displayed over the background image, and a filmstrip that is displayed over the background image and that comprises a set of images that compose an animation when played back. The apparatus further includes a second means for providing a bundler that assembles the background image and the one or more interactive components into the interactive media object.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an interactive media object development system in accordance with an example embodiment.

FIG. 2 is a block diagram of an interactive media object development system in accordance with another example embodiment.

FIG. 3 is a block diagram of various components that together comprise an interactive media object development engine in accordance with an example embodiment.

FIG. 4 depicts a graphical user interface (GUI) screen that enables a user to begin developing a new interactive media object, continue development of an interactive media object, and/or add certain features to an interactive media object being developed in accordance with an example embodiment.

FIG. 5 depicts a GUI screen that enables a user to upload a filmstrip in accordance with an example embodiment.

FIG. 6 depicts a GUI screen that enables a user to add an overlay to an interactive media object being developed in accordance with an example embodiment.

FIG. 7 depicts a hotspotter GUI screen that enables a user to add various features to an interactive media object being developed in accordance with an example embodiment.

FIG. 8 depicts an enlarged view of a background image section of the GUI screen shown in FIG. 7.

FIG. 9 depicts a GUI screen that shows an updated background section in accordance with an example embodiment.

FIG. 10 depicts a GUI screen that presents a background image of an interactive media object being developed in accordance with an example embodiment.

FIG. 11 provides an enlarged view of a foreground image section of the GUI screen shown in FIG. 7.

FIG. 12 shows an example of an updated foreground image section in accordance with an example embodiment.

FIG. 13 depicts a GUI screen that presents a foreground image of an interactive media object being developed in accordance with an example embodiment.

FIG. 14 provides an enlarged view of a legend image section of the GUI screen shown in FIG. 7.

FIG. 15 depicts a GUI screen that presents a legend image of an interactive media object being developed in accordance with an example embodiment.

FIG. 16 shows an enlarged view of a hotspot section of the GUI screen shown in FIG. 7.

FIG. 17 depicts a GUI screen in which a user has selected and placed a basic hotspot interface element over a portion of a background image in accordance with an example embodiment.

FIG. 18 depicts a GUI screen having an expanded interactive toggle menu in accordance with an example embodiment.

FIG. 19 depicts a GUI screen in which a user has selected and placed an audio hotspot interface element over a portion of a background image in accordance with an example embodiment.

FIG. 20 depicts a GUI screen in which a user has selected and placed a video hotspot interface element over a portion of a background image in accordance with an example embodiment.

FIG. 21 depicts a GUI screen in which a user has selected and placed a text hotspot interface element over a portion of a background image in accordance with an example embodiment.

FIG. 22 depicts a GUI screen in which a user has selected and placed a zoom hotspot interface element over a portion of a background image in accordance with an example embodiment.

FIG. 23 depicts a GUI screen in multiple overlays have been inserted over a background image in accordance with an example embodiment.

FIG. 24 shows an enlarged view of a filmstrip section of the GUI screen shown in FIG. 7.

FIG. 25 depicts a GUI screen including an example of a timeline style control mechanism in accordance with an example embodiment.

FIGS. 26 and 27 depict GUI screens that respectively show a slider at different positions along a timeline style control mechanism in accordance with example embodiments.

FIG. 28 depicts a GUI screen including an example of an animation style control mechanism in accordance with an example embodiment.

FIG. 29 depicts a GUI screen including an example of a 360-degree style control mechanism in accordance with an example embodiment.

FIG. 30 depicts a GUI screen showing the designation of a keyframe in accordance with an example embodiment.

FIG. 31 depicts a GUI screen showing the configuration of a keyframe in accordance with an example embodiment.

FIG. 32 depicts a GUI screen showing an expanded frame section in accordance with an example embodiment.

FIG. 33 depicts a GUI screen showing an outline element in accordance with an example embodiment.

FIG. 34 depicts a GUI screen showing an expanded outline element in accordance with an example embodiment.

FIG. 35 depicts a GUI screen showing the activating and displaying of a popover in accordance with an example embodiment.

FIG. 36 shows a block diagram of a filmstrip module in accordance with an example embodiment.

FIG. 37 depicts a GUI screen in which a user is enabled to designate an entire background image as being zoomable.

FIG. 38 depicts a flowchart of a method for enabling a user to develop an interactive media object in accordance with an example embodiment.

FIG. 39 shows an interactive media object in accordance with an example embodiment.

FIG. 40 is a block diagram of an example computer system in which embodiments may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

Systems, methods and computer program products are described herein that enable a user (e.g., a developer) to develop an interactive media object. The interactive media object may be suitable for embedding in a digital book, a web page, or other application. Examples of interactive media objects include, but are not limited to, a widget, a gadget, etc. A developer may be provided with a graphical user interface (GUI) that enables the developer to add one or more components to the interactive media object. For example, a developer may be enabled to provide a background image. The developer may be further enabled to insert a foreground image and/or one or more overlays (i.e., an image that can be toggled on or off by a user (e.g., an end-user for which the interactive media object is developed)) over the background image. The developer may further be able to insert “hotspots” and/or filmstrips over the background image, foreground image, and/or the overlay(s). A bundler may be provided that assembles the one or more components into the interactive media object.

Hotspots may provide multimedia content (e.g., text, images, audio and/or video) that supplements the content shown by the background image, the foreground image and/or the overlay(s). The multimedia content provided by the hotspots may be displayed directly over the background image, foreground image, and/or the overlay(s), or may be provided in response to activating an interface element (e.g., a button) corresponding to the hotspot.

A filmstrip may be a set of images (e.g., frames) that compose an animation when played back. Filmstrips may be played back using one or more control mechanisms (e.g., an animation-style control mechanism, a timeline-style control mechanism, and/or a 360-degree style control mechanism) that may be selected using the GUI during development. Frame(s) of the filmstrip may also be designated as key frames, which are user-designated frames (e.g., frames designated by a developer) that can be associated with additional content and/or hotspots.

The developer may be further able to provide zoom capabilities that allow for the zooming in or zooming out (i.e., enlargement or reduction) of certain portions of the background image, foreground image and/or overlay(s). Upon zooming in, the developer may be enabled to provide additional information (e.g., multimedia content).

In accordance with an embodiment, the interactive media object may be used as an instructive guide or part of a digital book that demonstrates the phases of a particular war or battle. In accordance with such an embodiment, the background image may correspond to a map. The foreground image and/or overlays(s) may display geographic coordinates, historical and/or modern civic information (e.g., roads and towns) over the map. A filmstrip may be used to show an animation over the map (e.g., to reflect troop movement over a certain period of time, change in territory ownership over time, etc.). Hotspots may be used to show additional information pertaining to certain portions of the map, soldiers, etc. or any other feature shown in the background image, foreground image, and/or overlay(s). A user (e.g., an end-user) may further be able to zoom into a portion of the map to expose a higher level of detail for that portion.

Section II below will describe example interactive media object development systems in accordance with embodiments. Section III will describe example GUI screens for enabling a developer to develop an interactive media object in accordance with embodiments. Section IV will describe an example method for enabling a developer to develop an interactive media object in accordance with an embodiment. Section V will describe an example interactive media object that may be developed using the interactive media object development systems and methods described herein. Section VI will describe an example processor-based computer system that may be used to implement various embodiments described herein. Finally, Section VII will provide some concluding remarks.

### II. Example Interactive Media Object Development Systems

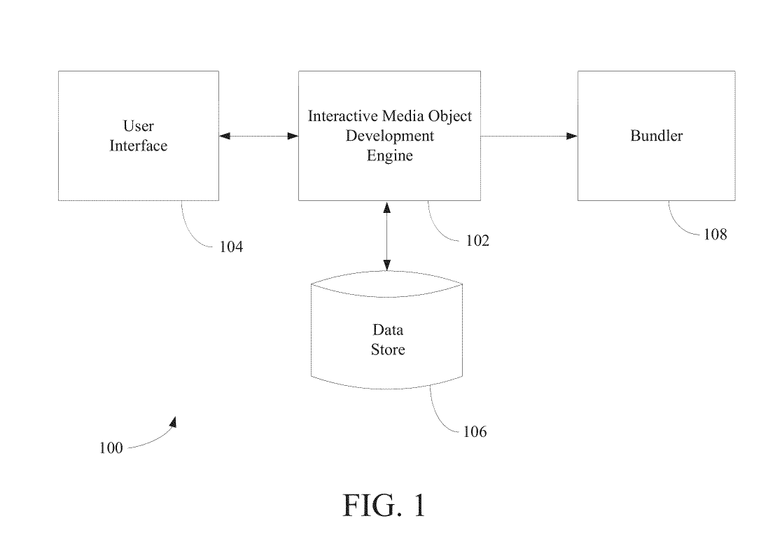

FIG. 1 is a block diagram of an interactive media object development system 100 in accordance with an embodiment. As shown in FIG. 1, system 100 includes an interactive media object development engine 102. Interactive media object development engine 102 may be configured to provide a user interface 104 for developing an interactive media object. User interface 104 may provide one or more interactive components (e.g., interface elements) that enable a developer to add one or more features to the interactive media object being developed. In accordance with an embodiment, the interactive media object may be an HTML-based widget or gadget. Examples of features may include, but are not limited to, multimedia content and/or interface elements (e.g., interactive buttons), which, when activated cause various operations to occur when interacting with an interactive media object. Examples of multimedia content include, but are not limited to, text, images, video, audio and/or filmstrips. User interface 104 may also include one or more editors and/or modules that enable the developer to configure the interface elements and/or filmstrips.

The multimedia content used to develop the interactive media object may be stored in and retrieved from a data store 106 using one or more of the interface elements of user interface 104.

In response to a developer adding feature(s) to the interactive media object, code (e.g., JavaScript) and/or information associated with the formatting of the interactive media object (e.g., Cascading Style Sheet (CSS) files) may be automatically generated, updated, and/or stored in data store 106.

Bundler 108 may be configured to assemble the features into the interactive media object. For example, bundler 108 may be configured to query data store 106 for data associated with the interactive media object (e.g., the multimedia content and/or interface elements), code and/or formatting information stored therein. In response, data store 106 may return the data, code, and/or formatting information to bundler 108. Bundler 108 may then store the retrieved data, code, and/or formatting information into a specified location (e.g., a directory or folder), encode the data, code, and/or formatting information into a file suitable for data transmission (e.g., a JavaScript Object Notation (JSON) file), and store this file into the same specified location. Bundler 108 may also add additional files to the specified location that enable the interactive media object to be displayed in another application (e.g., a Web site, a digital book, or any application capable of supporting HTML rendering (e.g., HTML5 rendering)). The additional files may include a “main” file and a manifest file. The “main” file loads the code and formatting information, and the manifest file contains information that enables the other application to process the assembled interactive media object. Thereafter, bundler 108 may then compress the folder into a package (e.g., a .WDGT package) and provides the compressed folder to the developer. The developer may then embed the package into any suitable application.

In accordance with one embodiment, the various components of system 100 are implemented on the same device (e.g., a computer). In accordance with another embodiment, the various components of system 100 may be implemented in a distributed fashion across a plurality of devices.

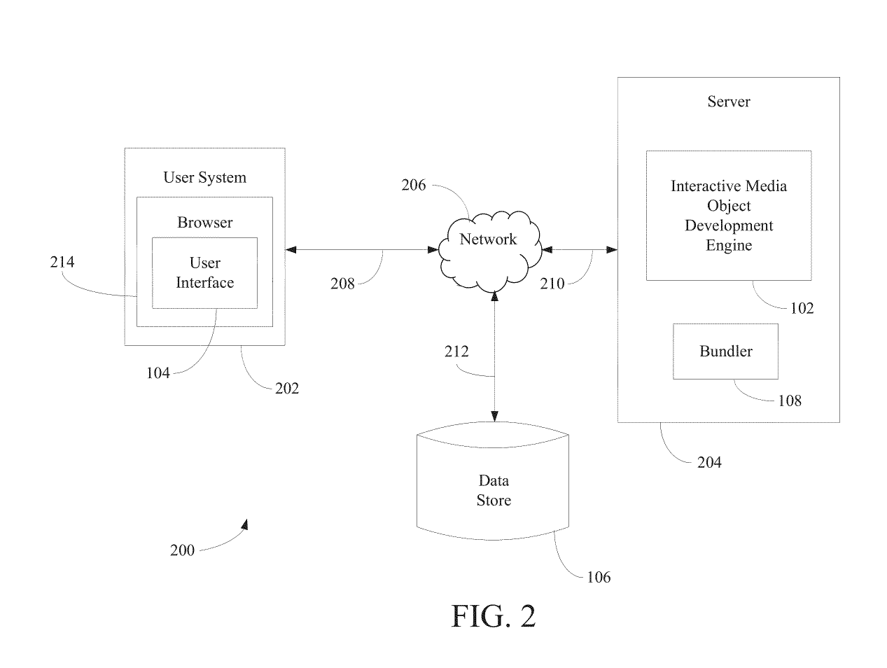

For example, FIG. 2 is a block diagram of an interactive media object development system 200 in accordance with an embodiment in which system components are implemented in a distributed fashion across a plurality of devices.

System 200 includes a user system 202, a server 204, and a network 206. As shown in FIG. 2, user interface 104 may be implemented on user system 202, and interactive media object development engine 102 and bundler 108 may be implemented on server 204. Communication among user system 202, server 204 and data store 106 is carried out over network 206. Network 206 may be a LAN (local area network), a WAN (wide area network) such as the Internet, or any combination of networks. User system 202 is coupled to network 206 via a communication link 208, server 204 is coupled to network 206 via a communication link 210 and data store 106 is coupled to network 206 via a communication link 212. Communication links 208, 210 and 212 may each include wired and/or wireless links. Examples of communication links 208, 210 and 212 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Server 204 comprises a computer or other processing system that includes one or more processors capable of communicating with user system 202. Server 206 is configured to host a site (e.g., a Web site) published by a publisher so that such a site is accessible to users of system 200 via user system 204.

Server 204 is further configured to execute software programs that provide information to users in response to receiving requests, such as hypertext transfer protocol (HTTP) requests, from users. For example, the information may include Web resources, such as Web pages, images, other types of files, etc. The Web pages may be provided as hypertext markup language (HTML) documents and objects (e.g., files) that are linked therein, for example.

User system 202 is a computer or other processing system that includes one or more processors that are capable of communicating with server 204. For example, user system 202 may include a client that enables a user to access, view, and/or interact with Web resources (e.g., Web sites) that are hosted by server 204. For instance, a client may be a Web browser or any other suitable type of client. As shown in FIG. 2, user system 202 includes a browser 214.

Browser 214 is a software application that is configured to retrieve, present, and traverse network-accessible content, such as Web resources provided by server 204. Some well-known Web browsers include Internet Explorer® (published by Microsoft Corporation of Redmond, Wash.), Firefox® (published by Mozilla Corporation of Mountain View, Calif.), and Chrome™ (published by Google Inc. of Mountain View, Calif.).

Interactive media object development engine 102 may be configured to communicate with browser 214 executing on user system 202 to enable users of user system 202 to develop interactive media objects. For example, in accordance with an embodiment, upon connecting to sever 102, interactive media object development engine 102 provides documents (e.g., HTML documents) and code (e.g., JavaScript code) that are received by browser 214 and processed thereby to cause user interface 104 to be rendered on a screen of user system 202 and to enable a user to interact with user interface 104 to develop interactive media objects.

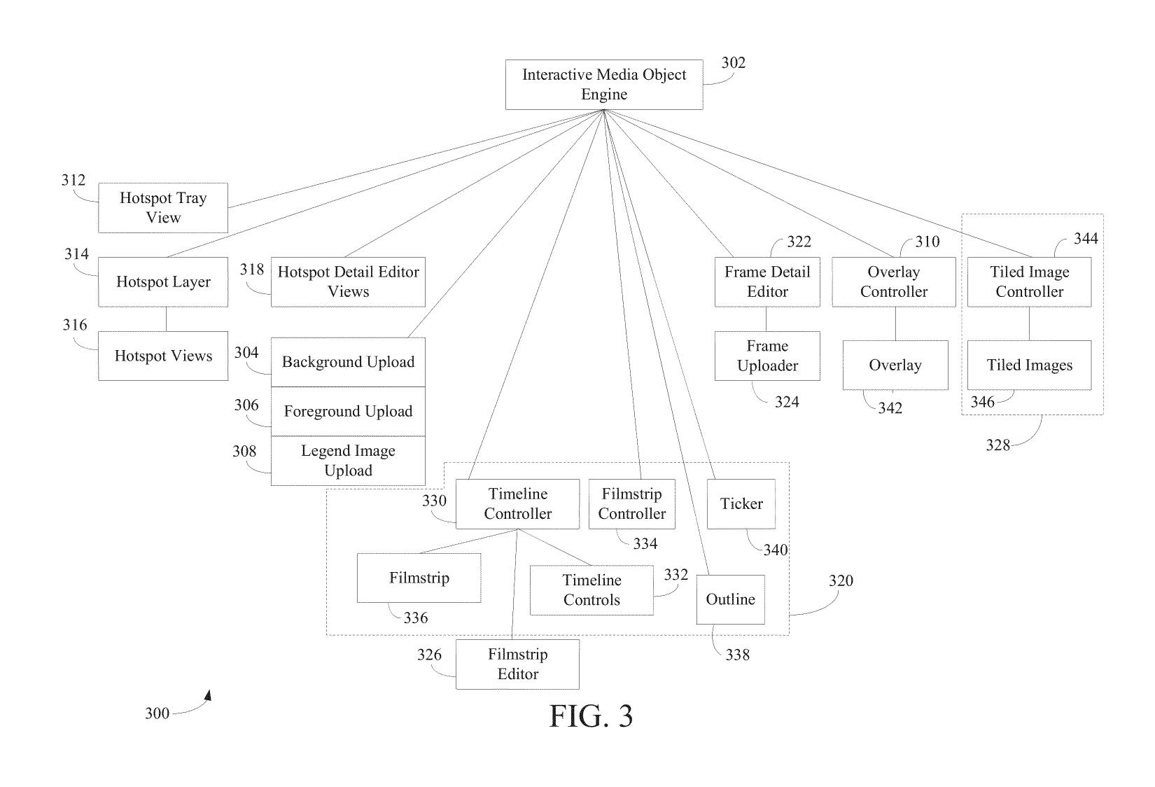

FIG. 3 depicts a block diagram 300 of various components that together comprise an interactive media object development engine 302 in accordance with an embodiment. Interactive media object development engine 302 may be an example of interactive media object development engine 102 as discussed above in reference to FIGS. 1 and 2. As shown in FIG. 3, the components of interactive media object development engine 302 may include a background upload module 304, a foreground upload module 306, a legend image upload module 308, an overlay controller module 310, a hotspot tray view module 312, a hotspot layer module 314, a hotspot views module 316, a hotspot detail editor views module 318, a filmstrip module 320, a frame detail editor module 322, a frame uploader 324, a filmstrip editor module 326 and a zoom module 328. Filmstrip module 320 may include a timeline controller module 330, a timeline controls module 332, and a filmstrip controller 334. Zoom module 328 may include a tiled image controller 344.

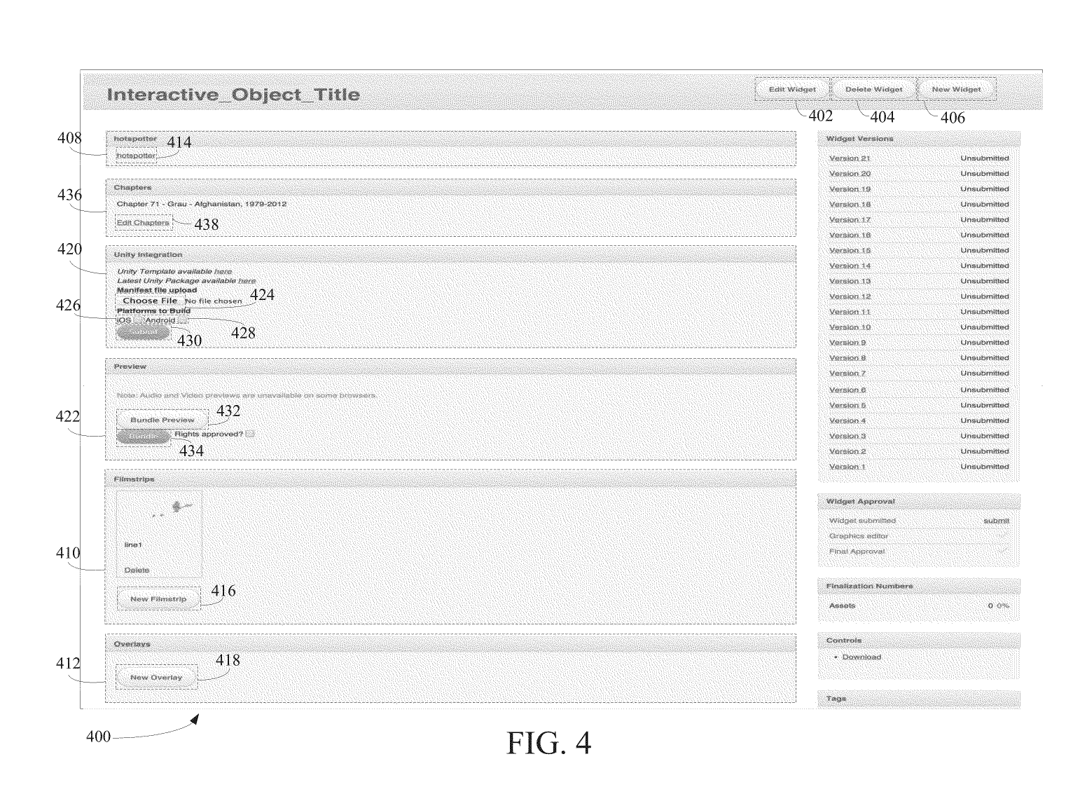

Each of these modules may be configured to provide a certain functionality that is made accessible to a developer via user interface 104. For example, background upload module 304 may be configured to provide functionality that enables a developer to add a background image to an interactive media object being developed. Foreground upload module 306 may be configured to provide functionality that enables a developer to add a foreground image to the interactive media object being developed. Legend image upload module 308 may be configured to provide functionality that enables a developer to add an image corresponding to a legend to the interactive media object being developed. Hotspot tray view module 312, hotspot layer module 314, hotspot views module 316 and hotspot detail editor views module 318 may provide functionality that enables a developer to add hotspots to the interactive media object being developed and view such hotspots. Filmstrip module 320, filmstrip editor module 326, frame detail editor module 322 and frame uploader module 324 may be configured to provide functionality that enables a developer to add a filmstrip 336 to the interactive media object being developed, configure such filmstrip 336, and cause information associated with such filmstrip 336 (e.g., an outline 338 and/or ticker information 340) to be displayed. Overlay controller 310 may provide functionality that enables a developer to add an overlay 342 to the interactive media object being developed and enable and/or disable such overlay 342. Zoom module 328 may be configured to provide functionality that enables a user (e.g., an end-user) to zoom in or zoom out of one or more portions of an image of the interactive media object being developed and/or provide a tiled version of that image (e.g., tiled images 346) upon zooming into that image. The various modules of FIG. 3 will be described in more detail herein with reference to FIGS. 4-37.

### III. Example Graphical User Interface Screens for Enabling a Developer to Develop an Interactive Media Object

Various examples of how system 100 and system 200 may be used to develop an interactive media object will now be described in reference to FIGS. 4-37. In particular, FIGS. 4-37 provide illustrations of example GUI screens or portions of GUI screens that may be utilized to develop an interactive media object in accordance with embodiments described herein. Each of the GUI screens may comprise a portion of user interface 104 as discussed above in reference to FIGS. 1 and 2.

FIG. 4 depicts a GUI screen 400 that enables a developer to begin creating (i.e., developing) a new interactive media object, continue development of an interactive media object, and/or add certain features to an interactive media object being developed. The functionality provided by GUI screen 400 may be provided by interactive media object development engine 102 (as shown in FIG. 1 and FIG. 2) or interactive media object development engine 302 (as shown in FIG. 3). As shown in FIG. 4, GUI screen 400 may include an interface element 402, an interface element 404 and an interface element 406. Interface element 402, when activated, may enable a developer to edit an interactive media object being developed. Interface element 404, when activated, may enable a developer to delete an interactive media object that was previously developed (or is currently in development). Interface element 406, when activated, may enable a developer to create (i.e., develop) a new interactive media object.

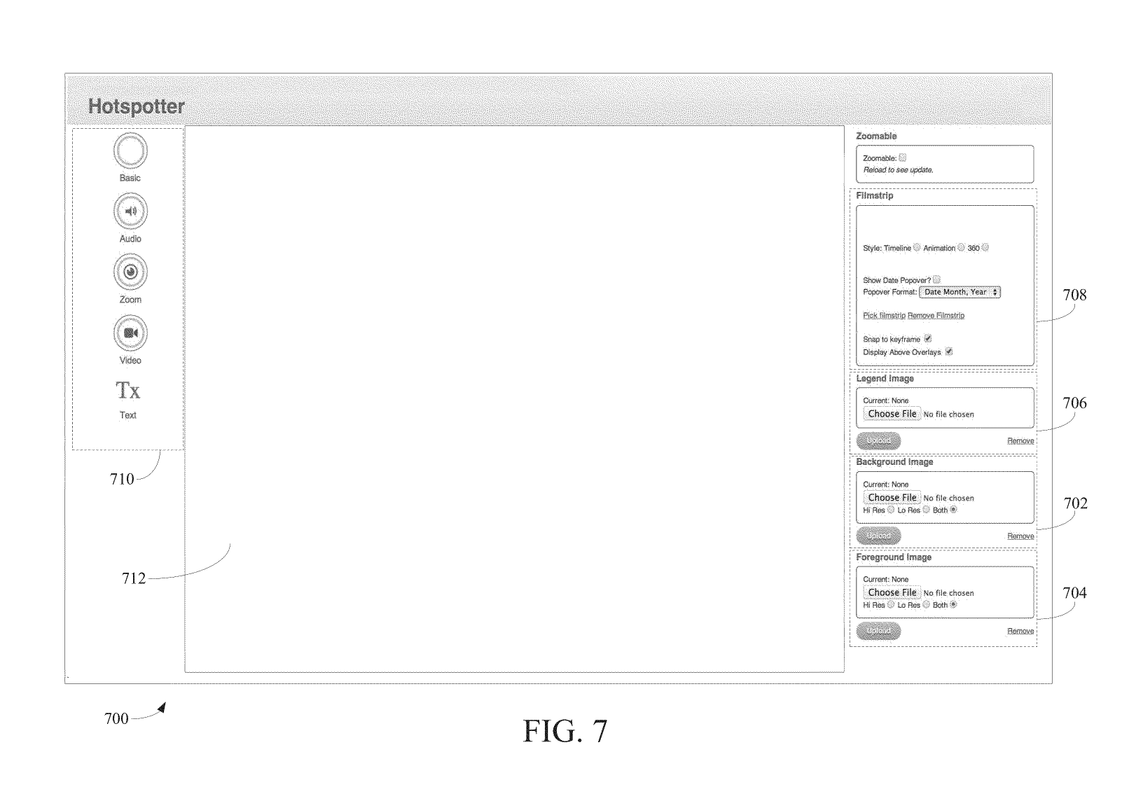

GUI screen 400 may also include a hotspotter section 408, a filmstrips section 410 and an overlays section 412. Hotspotter section 408 may include an interface element 414. Interface element 414 may comprise a button, which, when activated, may cause another GUI screen (e.g., hotspotter GUI screen 700, as shown in FIG. 7) to be presented to the developer, which enables the developer to add various features to the interactive media object. Hotspotter GUI screen 700 is described in greater detail below in reference with FIG. 7.

Filmstrips section 410 may include an interface element 416. Interface element 416 may comprise a button, which, when activated, may cause another GUI screen to be presented to the developer, which enables the developer to upload a filmstrip to data store 106.

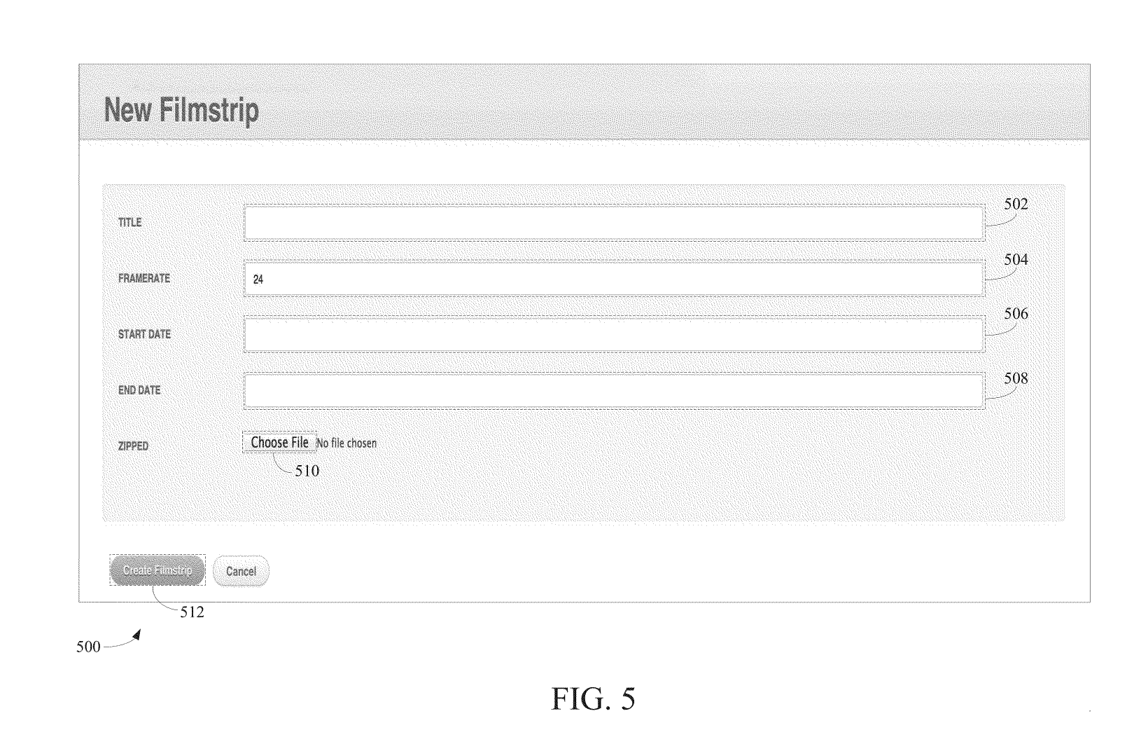

For example, FIG. 5 illustrates a GUI screen 500 that enables the developer to upload a filmstrip to data store 106. As shown in FIG. 5, GUI screen 500 includes an interface element 502, an interface element 504, an interface element 506, an interface element 508, an interface element 510 and an interface element 512. Each of interface elements 502, 504, 506 and 508 may comprise a text box. Interface element 502, when activated, enables the developer to enter in a title for the filmstrip. Interface element 504, when activated, enables the developer to define a frame rate at which the filmstrip is played back. Interface element 506, when activated, enables the developer to enter in a start position (e.g., a start time or start date) at which the filmstrip is to be played back. Interface element 508, when activated, enables the developer to enter in an end position (e.g., an end time or end date) at which playback of the filmstrip is to end. Interface element 510 may comprise a button, which, when activated, enables a developer to select a filmstrip to be uploaded that may be included in the interactive media object being developed. Interface element 512 may comprise a button, which, when activated, causes the selected filmstrip to be uploaded. The filmstrip image may be uploaded to data store 106. Filmstrips that have been uploaded may be added to an interactive media object via hotspotter GUI page 700. Filmstrips and their usage within an interactive media object is described below in Subsection F.

Referring again to FIG. 4, overlays section 412 includes an interface element 418. Interface element 418 may be a button, which, when activated, presents another GUI screen that enables the developer to select one or more overlays to be added to the interactive media object being developed.

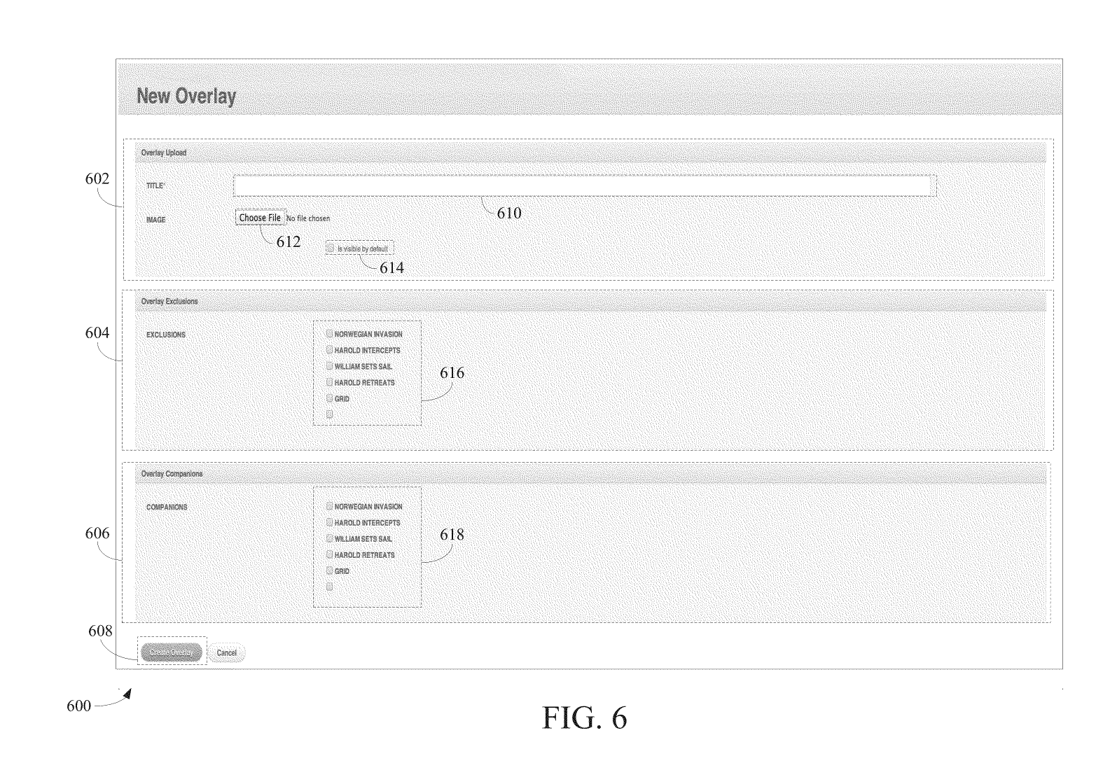

For example, FIG. 6 shows an example GUI screen 600 that enables a developer to add an overlay to the interactive media object being developed. As shown in FIG. 6, GUI screen 600 includes an overlay upload section 602, an overlay exclusions section 604, an overlay companions section 606, and an interface element 608.

Overlay upload section 602 may include an interface element 610, an interface element 612, and an interface element 614. Interface element 610 may comprise a text box in which a developer can enter a title for an overlay being added. Interface element 612 may comprise a button, which, when activated, enables the developer to selectively load an image to be used as the overlay. Interface element 614 may comprise a check box, which, when selected, causes the loaded overlay to be displayed by the interactive media object by default.

Overlay exclusions section 604 may enable the developer to select other overlays that have been previously loaded to be deactivated (i.e., not displayed) when the present overlay is displayed to a user (e.g., an end-user) as part of the interactive media object. For example, as shown in FIG. 6, overlay exclusions section 604 may comprise a list 616 of previously loaded overlays, with each overlay in list 616 being accompanied by an interface element (e.g., a check box). A developer may select which overlay(s) are to be deactivated (i.e., excluded) by selecting the check box(es) that are adjacent to those overlay(s).

Overlay companions section 606 may enable the developer to select other overlays that have been previously loaded to be activated (i.e., displayed) when the present overlay is displayed to a user (e.g., an end-user) as part of the interactive media object. For example, as shown in FIG. 6, overlay companions section 606 may comprise a list 618 of previously loaded overlays, with each overlay in list 618 being accompanied by an interface element (e.g., a check box). A developer may select which overlay(s) are to be activated along the present overlay by selecting the check box(es) that are adjacent to those overlay(s).

Once the developer has loaded the overlay and/or selected the other overlays for exclusion and/or accompaniment, the developer may add the overlay to the interactive media object upon activating interface element 608.

The overlays added to the interactive media object being developed may be presented to the developer via hotspotter GUI page 700. Overlays and their usage within an interactive media object are described below in Subsection E.

Referring again to FIG. 4, GUI screen 400 may also include a platform section 420 and a preview section 422. Platform section 420 may include an interface element 424, an interface element 426, an interface element 428 and an interface element 430. Interface element 424 may comprise a button, which, when activated, enables the developer to select a manifest file (as described above with reference to FIG. 1) that corresponds to a platform for which the interactive media object is to be bundled. The developer may select a particular platform using interface elements 426 and 428. For example, as shown in FIG. 4, a developer may select an iOS platform by activating interface element 426, and the developer may select an Android platform by activating interface element 428. Interface element 430 may comprise a button, which, when active causes the selected manifest to be uploaded.

Preview section 422 may include an interface element 432 and an interface element 434. Interface element 432 may comprise a button, which, when activated, causes the interactive media object to be bundled in a format that is suitable for the platform selected using platform section 420. The bundling process may be carried out in the manner described above in reference to bundler 108 of FIG. 1. Interface element 434 may comprise a button, which, when activated, bundles the interactive media object and causes the interactive media object to be rendered within user interface 104 in order to provide an interactive preview of the interactive media object. For example, after developing the interactive media object, the developer may activate interface element 434 to test out the features of the developed interactive media object. If the developer deems that the interactive media object is complete, the developer may then active interface element 432 to obtain a copy of the packaged version of the interactive media object, which the developer can then use to embed in another application.

In accordance with an embodiment in which an interactive media object is being developed for insertion within a digital book, GUI screen 400 may also include chapters section 436. Chapters section 436 may include an interface element 438. Interface element 438 may comprise a button, which, when activated, enables a developer to specify a chapter of the digital book for which the interactive media object is being developed.

FIG. 7 depicts a hotspotter GUI screen 700 that enables a developer to add various features to an interactive media object being developed. Features may include, but are not limited to, a background image, a foreground image, a legend image, hotspots, overlays, and filmstrips. As shown in FIG. 7, hotspotter GUI screen 700 includes a background image section 702, a foreground image section 704, a legend image section 706, a filmstrip section 708, a hotspot section 710, and a viewer section 712. Viewer section 712 may be used to display the interactive media object being developed. As shown in FIG. 7, viewer section 712 is empty, as no features have been added to the interactive media object. The features mentioned above are described below in the following subsections.

A. Background Image Section

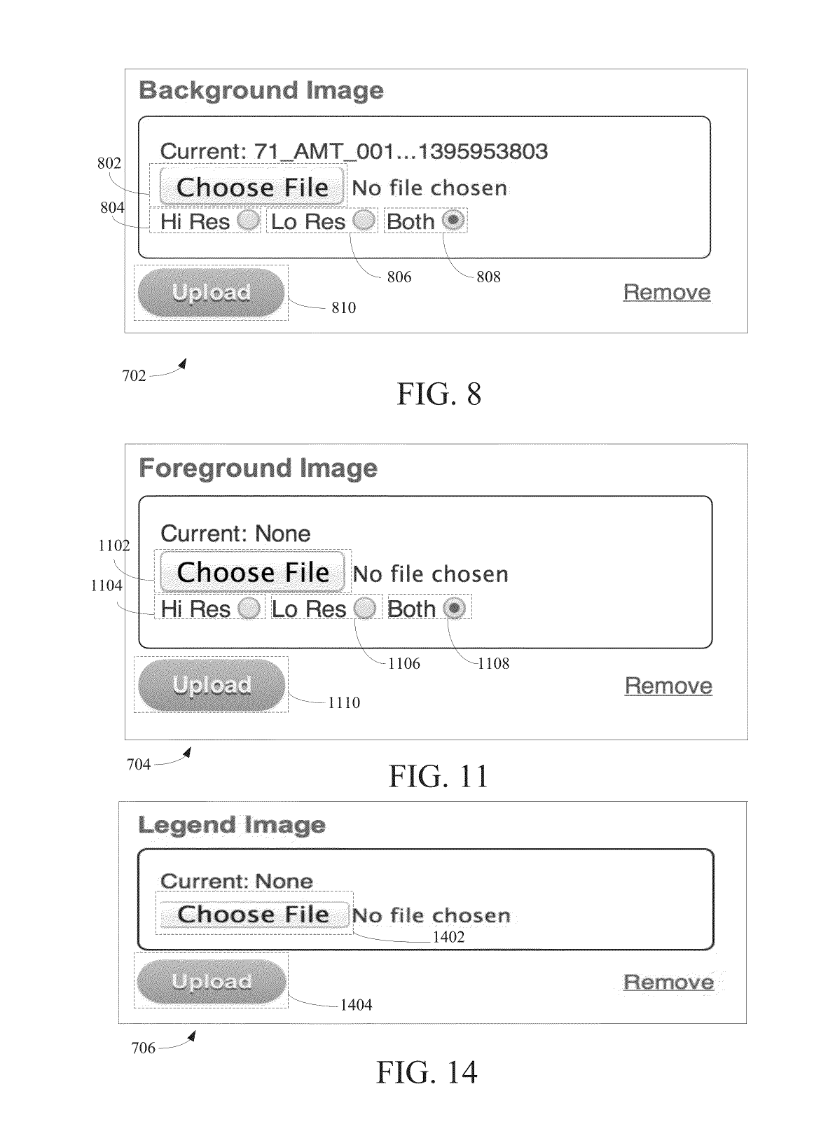

Background image section 702 enables a developer to add a background image to an interactive media object being developed. FIG. 8 shows an enlarged view of background image section 702. As shown in FIG. 8, background image section 702 includes an interface element 802, an interface element 804, an interface element 806, an interface element 808 and an interface element 810. Interface element 802 may comprise a button, which, when activated, enables a developer to select and upload an image to be used as a background image for an interactive media object. The image may be loaded from data store 106, which was described above in reference to FIGS. 1 and 2.

A developer may select a level of resolution of the background image to be loaded using interface elements 804, 806 and 808. For example, interface element 804, when selected, causes a high resolution version of the selected background image to be loaded. Interface element 806, when selected, causes a low resolution version of the background image to be loaded. Interface element 808, when selected, causes both a high resolution version and a low resolution version of the background image to be loaded. After selecting a background image to upload and the level of resolution for that background image, the background image may be uploaded by activating interface element 810.

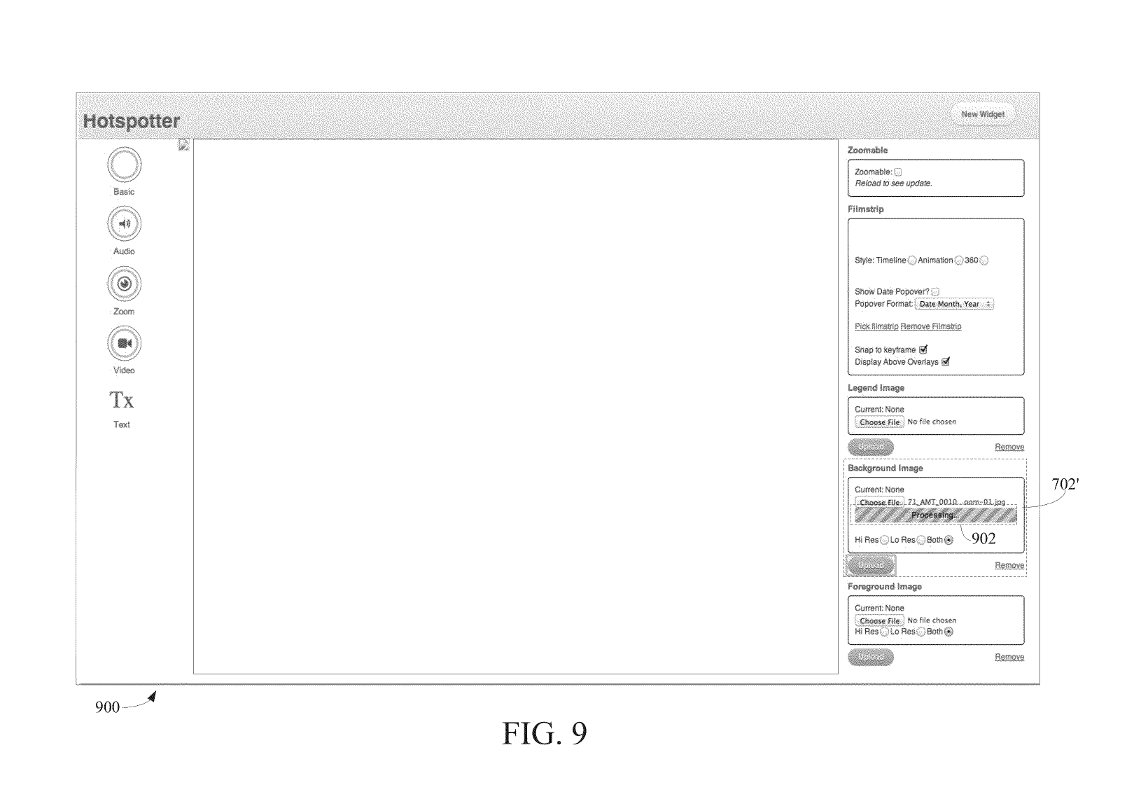

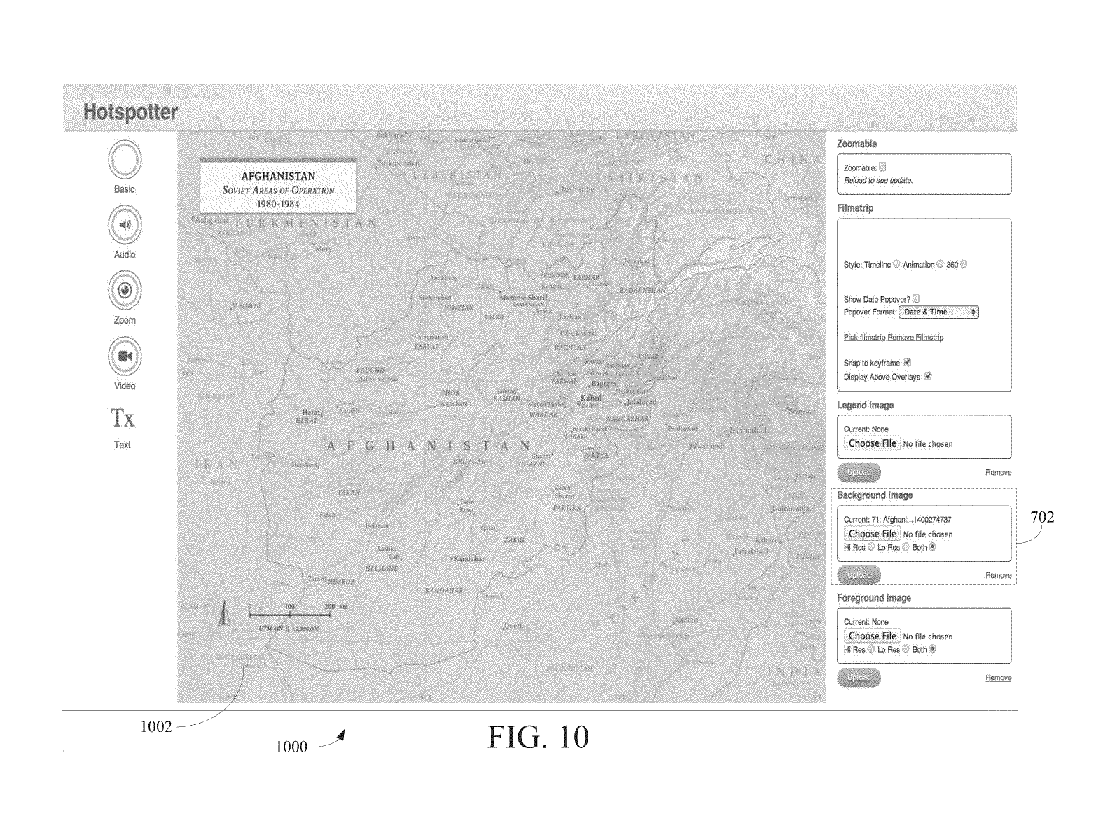

In accordance with an embodiment, upon activating interface element 810, background image section 702 is updated to reflect the progress of the background image loading operation. For example, FIG. 9 shows an example of an updated background image section 702′. As shown in FIG. 9, updated background image section 702′ includes a progress bar 902 that reflects the progress of the background image loading operation. As shown in FIG. 10, after the background image is loaded, the background image (e.g., background image 1002) is presented to the developer in viewer section 712. Additionally, background image section 702 is returned to its original form.

In an embodiment, the background image upload functionality is provided by background upload module 304 of interactive media object development engine 302 as described above in reference to FIG. 3.

B. Foreground Image Section

Referring again to FIG. 7, foreground image section 704 enables a developer to add a foreground image to an interactive media object being developed. FIG. 11 shows an enlarged view of foreground image section 704. As shown in FIG. 11, foreground image section 704 includes an interface element 1102, an interface element 104, an interface element 1106, an interface element 1108 and an interface element 1110. Interface element 1102 may comprise a button, which, when activated, enables a developer to select and upload an image to be used as a foreground image for an interactive media object. The image may be loaded from data store 106, which was described above in reference to FIGS. 1 and 2.

A developer may select a level of resolution of the foreground image to be loaded using interface elements 1104, 1106 and 1108. For example, interface element 1104, when selected, causes a high resolution version of the selected foreground image to be loaded. Interface element 1106, when selected, causes a low resolution version of the foreground image to be loaded. Interface element 1108, when selected, causes both a high resolution version and a low resolution version of the foreground image to be loaded. After selecting a foreground image to upload and the level of resolution for that foreground image, the foreground image may be uploaded by activating interface element 1110.

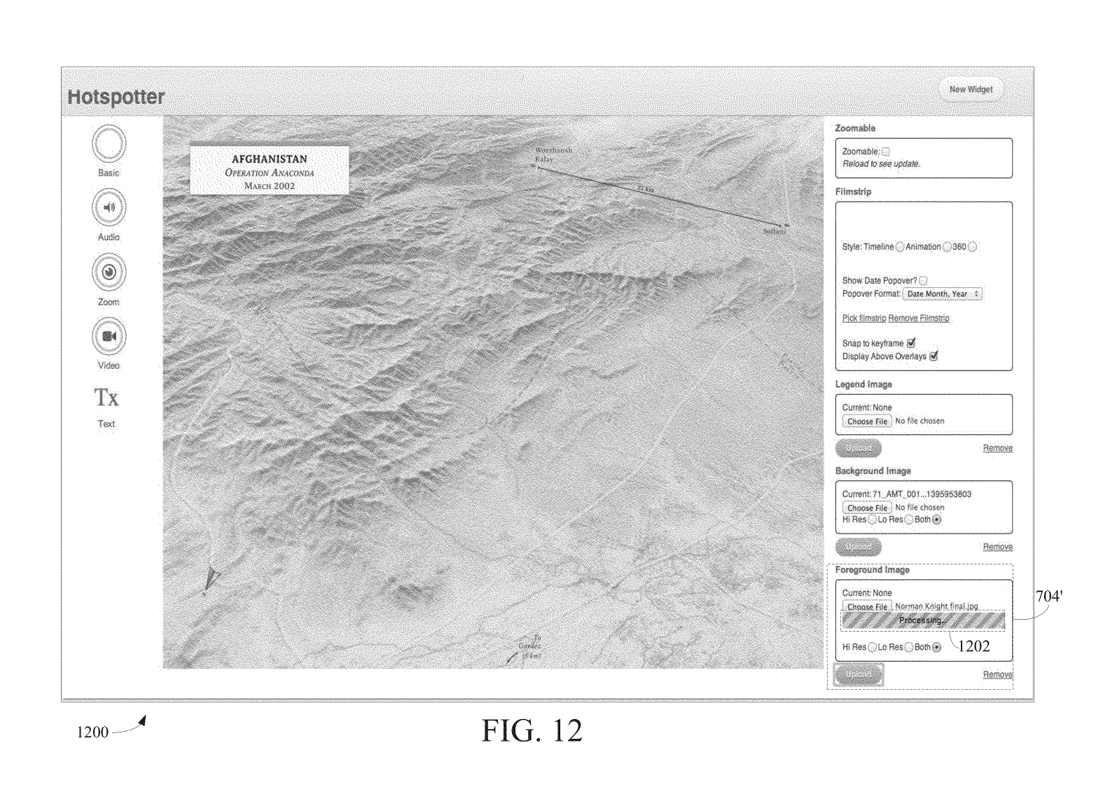

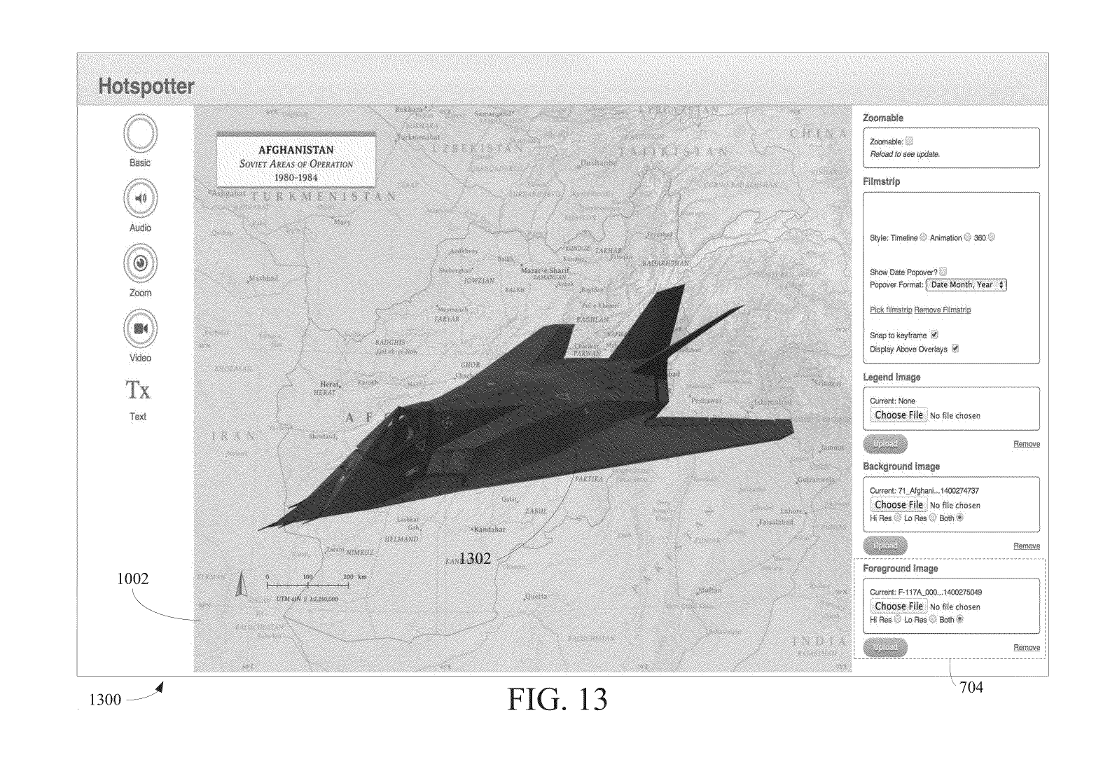

In accordance with an embodiment, upon activating interface element 1110, foreground image section 704 is updated to reflect the progress of the foreground image loading operation. For example, FIG. 12 shows an example of an updated foreground image section 704′. As shown in FIG. 12, updated foreground image section 704′ section includes a progress bar 1202 that reflects the progress of the foreground image loading operation. As shown in FIG. 13, after the foreground image is loaded, the foreground image (e.g., foreground image 1302) is presented to the developer. For example, foreground image 1302 is inserted over background image 1002. Additionally, foreground image section 704 is returned to its original form.

In an embodiment, the foreground image upload functionality is provided by foreground upload module 306 of interactive media object development engine 302 as described above in reference to FIG. 3.

C. Legend Image Section

Referring again to FIG. 7, legend image section 706 enables a developer to add a legend image to an interactive media object being developed. FIG. 14 shows an enlarged view of legend image section 706. As shown in FIG. 14, legend image section 706 includes an interface element 1402 and an interface element 1404. Interface element 1402 may comprise a button, which, when activated, enables a developer to select and upload an image to be used as a legend image for an interactive media object. The image may be loaded from data store 106, which was described above in reference to FIGS. 1 and 2.

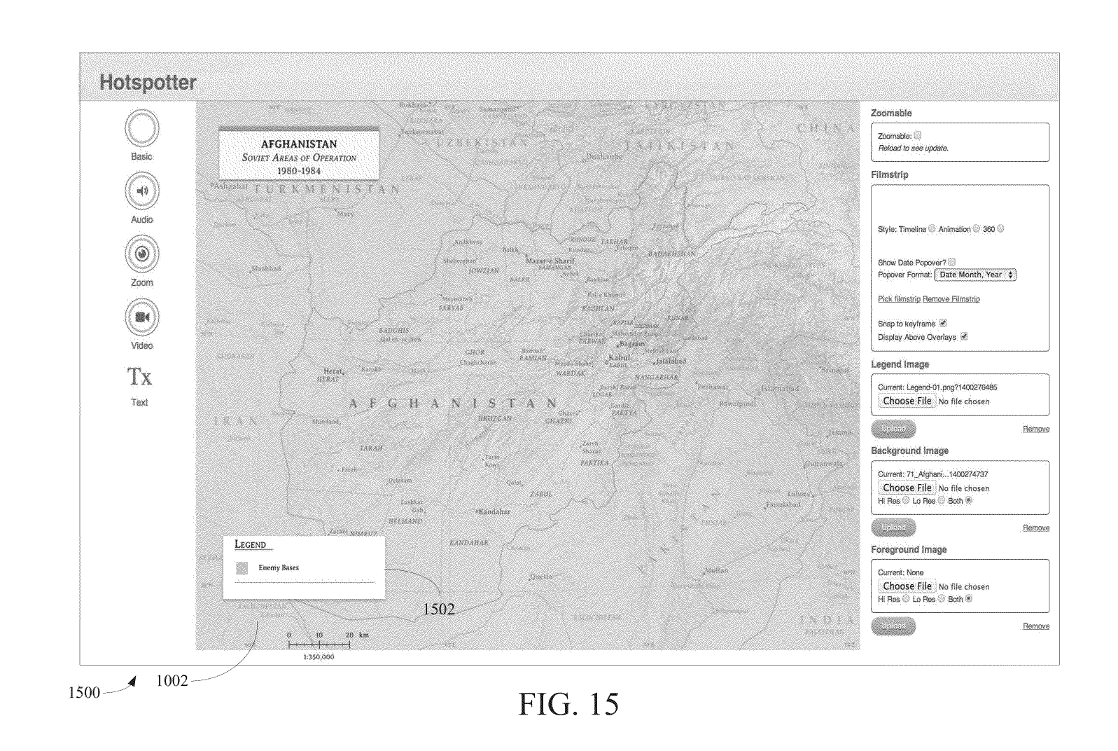

In accordance with an embodiment, upon activating interface element 1404, legend image section 706 is updated to reflect the progress of the legend image loading operation in a similar manner as described above with respect to background image section 702 and foreground image section 704. As shown in FIG. 15, after the legend image is loaded, the legend image (e.g., legend image 1502) is presented to the developer. For example, legend image 1502 is inserted over background image 1002.

In an embodiment, the legend image upload functionality is provided by legend upload module 308 of interactive media object development engine 302 as described above in reference to FIG. 3.

D. Hotspot Section

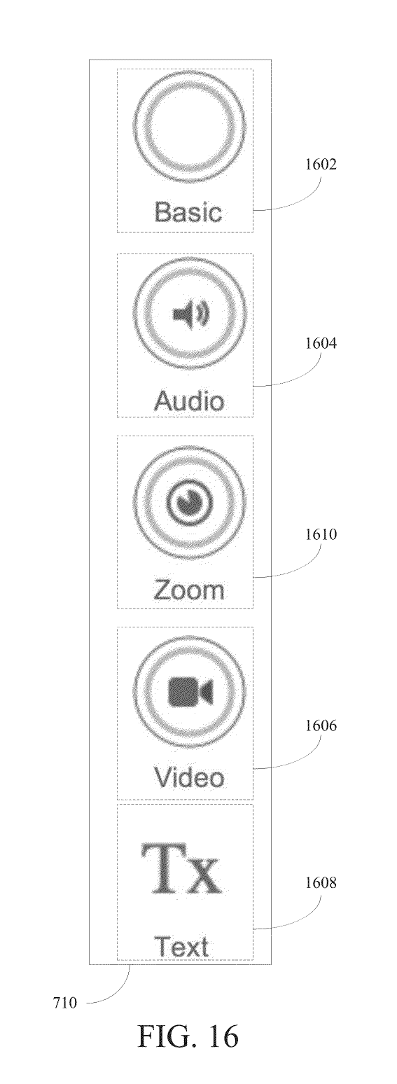

Referring again to FIG. 7, hotspot section 710 provides functionality that enables a developer to insert hotspots over a background image, a foreground image and/or overlay(s) included within an interactive media object. FIG. 16 shows an enlarged view of hotspot section 710. In accordance with an embodiment, hotspot section 710 may be presented by hotspot tray view module 312 of interactive media object engine 302 as described above in reference to FIG. 3. As shown in FIG. 16, hotspot section 710 includes a basic hotspot interface element 1602, an audio hotspot interface element 1604, a video hotspot interface element 1606, a text hotspot interface element 1608, and a zoom hotspot interface element 1610.

Basic hotspot interface element 1602 enables a developer to insert a basic hotspot over a portion of a background image, a foreground image and/or an overlay included within an interactive media object. A basic hotspot is an interface element (e.g., a button), which, when activated, causes textual content along with at least one of an image, video, or a three-dimensional (3D) filmstrip to be displayed. Audio hotspot interface element 1604 enables a developer to insert an audio hotspot over a portion of a background image, a foreground image and/or an overlay included within an interactive media object. An audio hotspot is an interface element, which, when activated, causes audio to be played back. Video hotspot interface element 1606 enables a developer to insert a video hotspot over a portion of a background image, a foreground image and/or an overlay included within an interactive media object. A video hotspot is an interface element, which, when activated, causes a video (e.g., an MPEG file, MPEG2 file, MPEG4 file, AVI file, etc.) to be played back. Text hotspot interface element 1608 enables a developer to insert a text hotspot over a portion of a background image, a foreground image and/or an overlay included within an interactive media object. A text hotspot displays textual content over a portion of a background image, a foreground image and/or an overlay. Zoom hotspot interface element 1610 enables a developer to insert a zoom hotspot over a portion of a background image, a foreground image and/or an overlay included within an interactive media object. A zoom hotspot is an interface element, which, when activated, causes a portion of a background image, a foreground image and/or an overlay to be zoomed in or zoomed out (i.e., enlarged or reduced in size).

A developer may insert a particular hotspot over a portion of a background image, a foreground image and/or an overlay by selecting one of basic hotspot interface element 1602, audio hotspot interface element 1604, video hotspot interface element 1606, text hotspot interface element 1608 or zoom hotspot interface element 1610 and placing it over the particular portion of the background image, the foreground image and/or the overlay. In one embodiment, a developer may “drag-and-drop” one of basic hotspot interface element 1602, audio hotspot interface element 1604, video hotspot interface element 1606, text hotspot interface element 1608 or zoom hotspot interface element 1610 over a particular portion of the background image, the foreground image, and/or the overlay to insert a particular hotspot

For example, “dragging-and-dropping” basic hotspot interface element 1602 over a particular portion of the background image, the foreground image, and/or the overlay causes a basic hotpot to be inserted thereover. “Dragging- and-dropping” audio hotspot interface element 1604 over a particular portion of the background image, the foreground image, and/or the overlay causes an audio hotpot to be inserted thereover. “Dragging-and-dropping” video hotspot interface element 1606 over a particular portion of the background image, the foreground image, and/or the overlay causes a video hotpot to be inserted thereover. “Dragging-and-dropping” text hotspot interface element 1608 over a particular portion of the background image, the foreground image, and/or the overlay causes a text hotpot to be inserted thereover. “Dragging-and-dropping” zoom hotspot interface element 1610 over a particular portion of the background image, the foreground image, and/or the overlay causes a zoom hotpot to be inserted thereover.

In accordance with an embodiment, the functionality that enables the selecting and placing of hotspot interface elements over a portion of a background image, a foreground image, and an overlay included within an interactive media object is provided by hotspot layer module 314 of interactive media object engine 302 as described above in reference to FIG. 3.

Upon selecting and placing a particular hotspot interface element over a particular portion of a background image, a foreground image and/or an overlay included within an interactive media object, the GUI (e.g., user interface 104 of FIGS. 1 and 2) may be updated to display a particular hotspot detail editor corresponding to the inserted hotspot.

1. Basic Hotspots

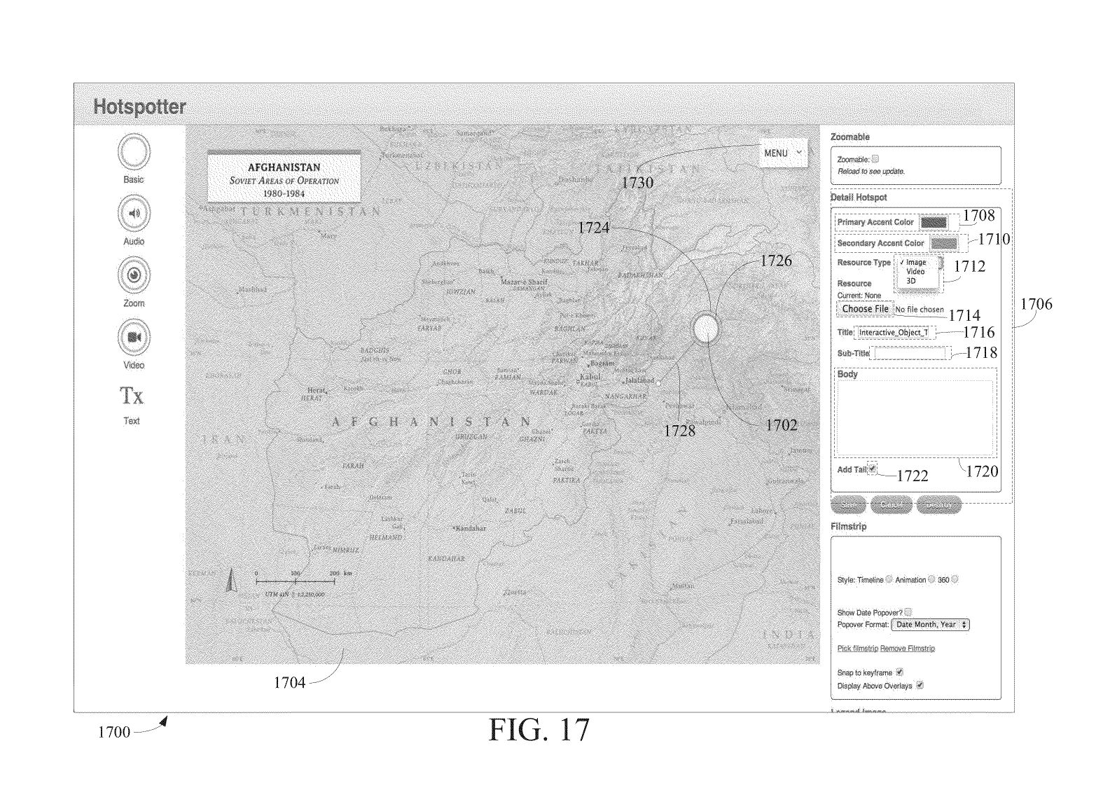

FIG. 17 depicts a GUI screen 1700 in which a developer has selected and placed a basic hotspot interface element over a portion of a background image 1704, thereby causing a basic hotspot 1702 to be inserted over background image 1704. Background image 1704 may be uploaded in a similar manner to that described above with respect to background image 1002 of FIG. 10. As shown in FIG. 17, a basic hotspot detail editor 1706 is also presented as a result of inserting basic hotspot 1702.

Basic hotspot detail editor 1706 may include an interface element 1708, an interface element 1710, an interface element 1712, an interface element 1714, an interface element 1716, an interface element 1718, an interface element 1720 and interface element 1722. Interface element 1708 may comprise a “drop-down” menu, which, when activated, enables a developer to select a particular color for an outer ring 1724 of basic hotpot 1702. Interface element 1710 may comprise a “drop-down” menu, which, when activated, enables a developer to select a particular color for an inner ring 1726 of basic hotpot 1702. Interface element 1712 may comprise a “drop-down” menu, which, when activated, enables a developer to select a resource type to be displayed upon activating basic hotspot 1702. Resource types may include, but are not limited to an image, a video, or a 3D filmstrip model. Interface element 1714 may comprise a button, which, when activated, enables a developer to load a resource corresponding to the selected resource type. The resource may be stored and retrieved from data store 106, which was described above in reference to FIGS. 1 and 2. Interface element 1716 may comprise a text box via which a developer can provide a title in association with a selected resource. Interface element 1718 may comprise a text box via which a developer can provide a sub-title in association with a selected resource. Interface element 1720 may comprise a text box via which a developer can provide a body of text in association with a selected resource. Interface element 1722 may comprise a check box, which, when checked, causes a configurable tail (e.g., tail 1728) to be added to basic hotspot 1702. Tail 1728 may serve as a pointer to a particular portion of a background image, foreground image and/or overlay over which basic hotspot 1702 is inserted. The developer may configure the length of tail 1728 by selecting and placing (e.g., “clicking-and-dragging”) an end point of tail 1728 to a desired position.

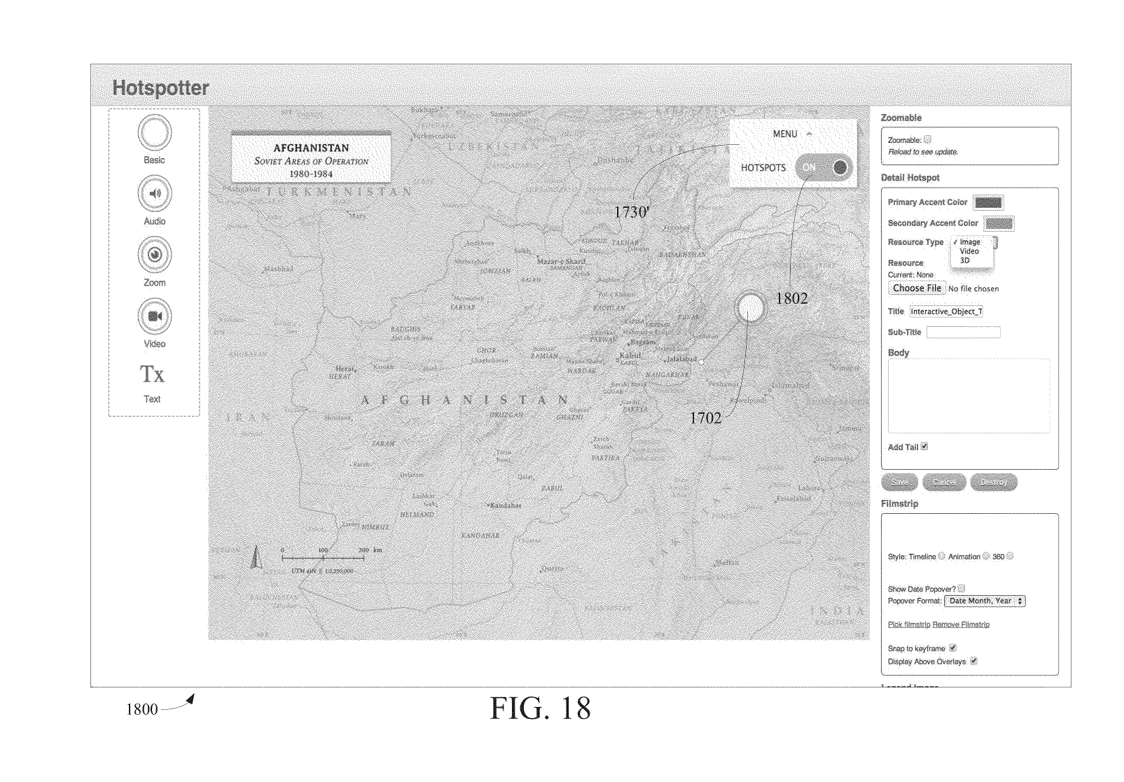

As further shown in FIG. 17, GUI screen 1700 includes an interactive toggle menu 1730. When activated, interactive toggle menu 1730 may be expanded to display an interactive switch element that enables a developer to turn on or turn off hotspots. For example, FIG. 18 shows a GUI screen 1800 having an expanded interactive toggle menu 1730′. As shown in FIG. 18, expanded interactive toggle menu 1730′ includes an interactive switch 1802 that enables a developer to turn on or turn off hotspots. As further shown in FIG. 18, interactive switch 1802 is in the “on” position. Therefore, basic hotspot 1702 is displayed. Upon switching interactive switch 1808 to “off,” basic hotspot 1702 will no longer be displayed.

Upon activating a basic hotspot, the selected resource associated with the basic hotspot may be presented along with the specified title, sub-title and/or body of text positioned proximate to the resource. In accordance with an embodiment, the functionality that presents the selected resource along with the specified title, sub-title and/or body of text is provided by hotspot views module 316 of interactive media object engine 302 as described above in reference to FIG. 3.

2. Audio Hotspots

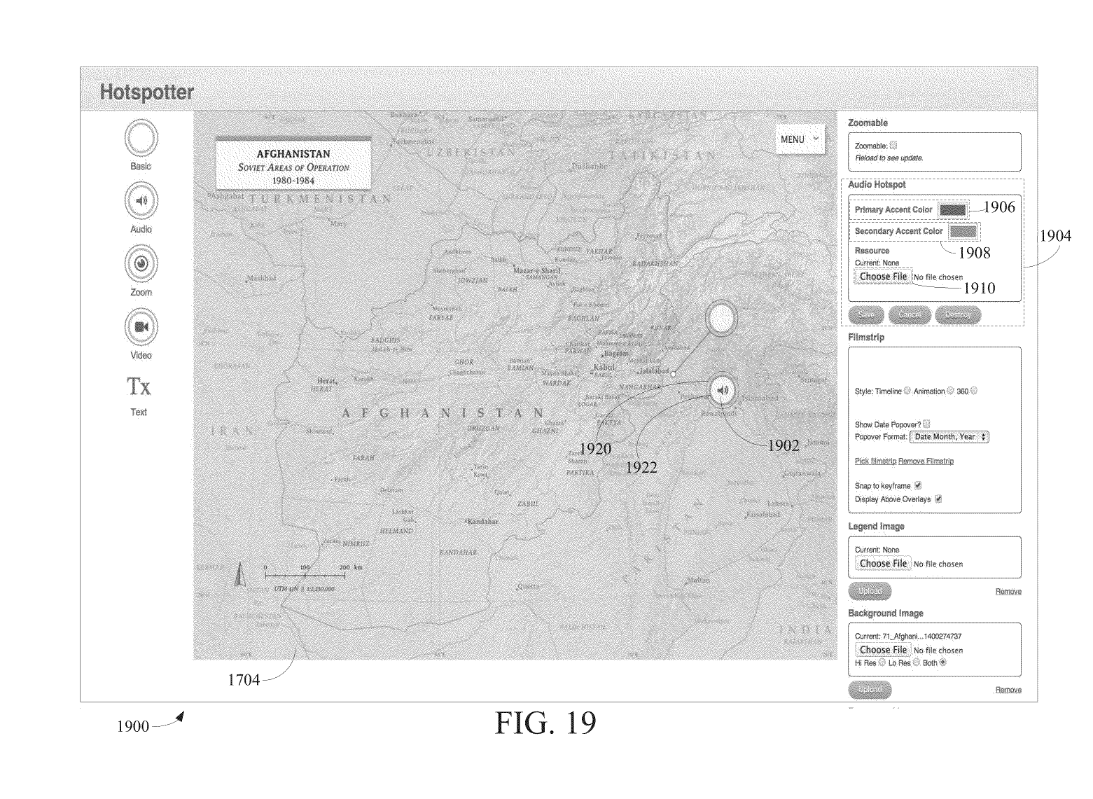

FIG. 19 depicts a GUI screen 1900 in which a developer has selected and placed an audio hotspot interface element over a portion of background image 1704, thereby causing an audio hotspot 1702 to be inserted over background image 1704. As shown in FIG. 19, an audio hotspot detail editor 1904 is also presented as a result of inserting audio hotspot 1902. Audio hotspot detail editor 1904 may include an interface element 1906, an interface element 1908 and an interface element 1910. Interface element 1906 may comprise a “drop-down” menu, which, when activated, enables a developer to select a particular color for an outer ring 1920 of audio hotspot 1902. Interface element 1908 may comprise a “drop-down” menu, which, when activated, enables a developer to select a particular color for an inner ring 1922 of audio hotpot 1902. Interface element 1910 may comprise a button, which, when activated, enables a developer to load an audio file (e.g., a WAV, MP3, etc.) to be played back upon activation of audio hotspot 1902. The audio file may be stored and retrieved from data store 106, which was described above in reference to FIGS. 1 and 2.

An interactive toggle menu (e.g., interactive toggle menu 1730, as described above with respect to FIGS. 17 and 18) may also be provided in response to selecting and placing an audio hotspot interface element (if one has not already been provided due to selecting and placing another hotspot interface element) over background image 1704.

3. Video Hotspots

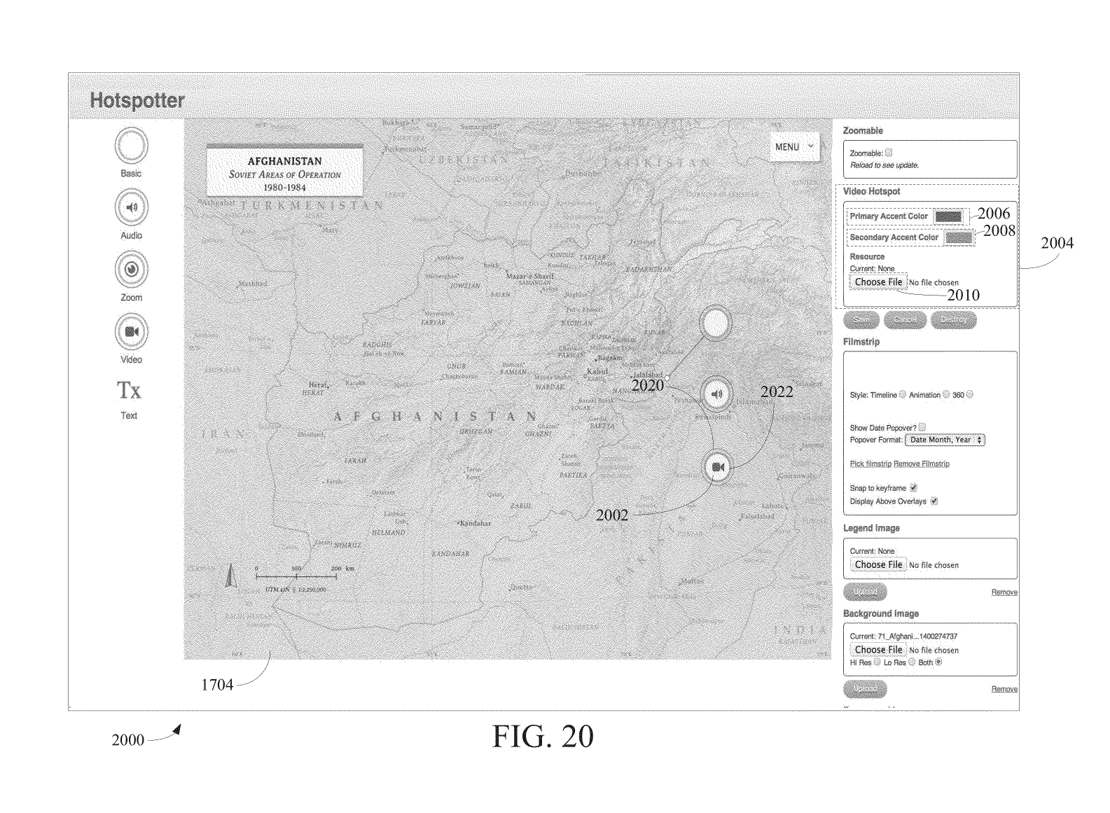

FIG. 20 depicts a GUI screen 2000 in which a developer has selected and placed a video hotspot interface element over a portion of background image 1704, thereby causing a video hotspot 2002 to be inserted over background image 1704. As shown in FIG. 20, a video hotspot detail editor 2004 is also presented as a result of inserting video hotspot 2002. Video hotspot detail editor 2004 may include an interface element 2006, an interface element 2008 and an interface element 2010. Interface element 2006 may comprise a “drop-down” menu, which, when activated, enables a developer to select a particular color for an outer ring 2020 of video hotspot 2002. Interface element 2008 may comprise a “drop-down” menu, which, when activated, enables a developer to select a particular color for an inner ring 2022 of video hotpot 2002. Interface element 2010 may comprise a button, which, when activated, enables a developer to load a video file to be played back upon activating video hotspot 2002. The video file may be stored and retrieved from data store 106, which was described above in reference to FIGS. 1 and 2.

An interactive toggle menu (e.g., interactive toggle menu 1730, as described above with respect to FIGS. 17 and 18) may also be added in response to selecting and placing a video hotspot interface element (if one has not already been added due to selecting and placing another hotspot interface element) over background image 1704.

4. Text Hotspot

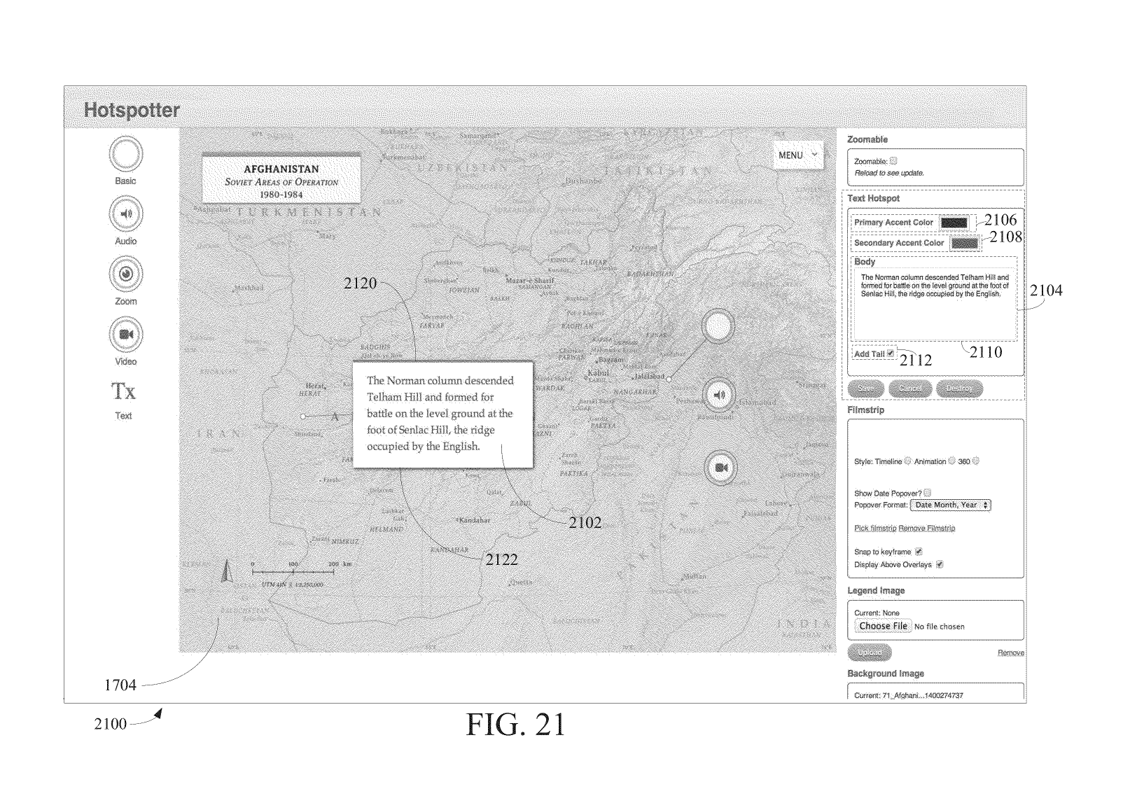

FIG. 21 depicts a GUI screen 2100 in which a developer has selected and placed a text hotspot interface element over a portion of background image 1704, thereby causing a text hotspot 2102 to be inserted over background image 1704. As shown in FIG. 21, a text hotspot detail editor 2104 is also presented as a result of inserting text hotspot 2102. Text hotspot detail editor 2104 may include an interface element 2106, an interface element 2108, an interface element 2110 and an interface element 2112. Interface element 2106 may comprise a “drop-down” menu, which, when activated, enables a developer to select a particular color for a top bar 2120 of text hotspot 2102. Interface element 2108 may comprise a “drop-down” menu, which, when activated, enables a developer to select a particular color for a bottom bar 2122 of text hotspot 2102. Interface element 2110 may comprise a text box, which, when activated, enables a developer to enter text to be shown in text hotspot 2102. Interface element 2112 may comprise a check box, which, when checked enables a developer to add a configurable tail (not shown) to text hotspot 2102. The developer may configure the tail in a similar manner as described above with respect to basic hotspot 1702 of FIG. 17.

Text hotspot 2102 is configured to display the text provided in interface element 2110. Text hotspot 2102 differs from the other hotspots in that it is not interactive (i.e., a user (e.g., an end-user) does not activate text hotspot 2102 to display or play back additional content. Instead, text hotspots simply display text). In accordance with an embodiment, the functionality that displays the text in text hotspot 2102 is provided by hotspot views module 316 of interactive media object engine 302 as described above in reference to FIG. 3.

An interactive toggle menu (e.g., interactive toggle menu 1730, as described above with respect to FIGS. 17 and 18) may also be added in response to selecting and placing a text hotspot interface element (if one has not already been added due to selecting and placing another hotspot interface element) over background image 1704.

5. Zoom Hotspots

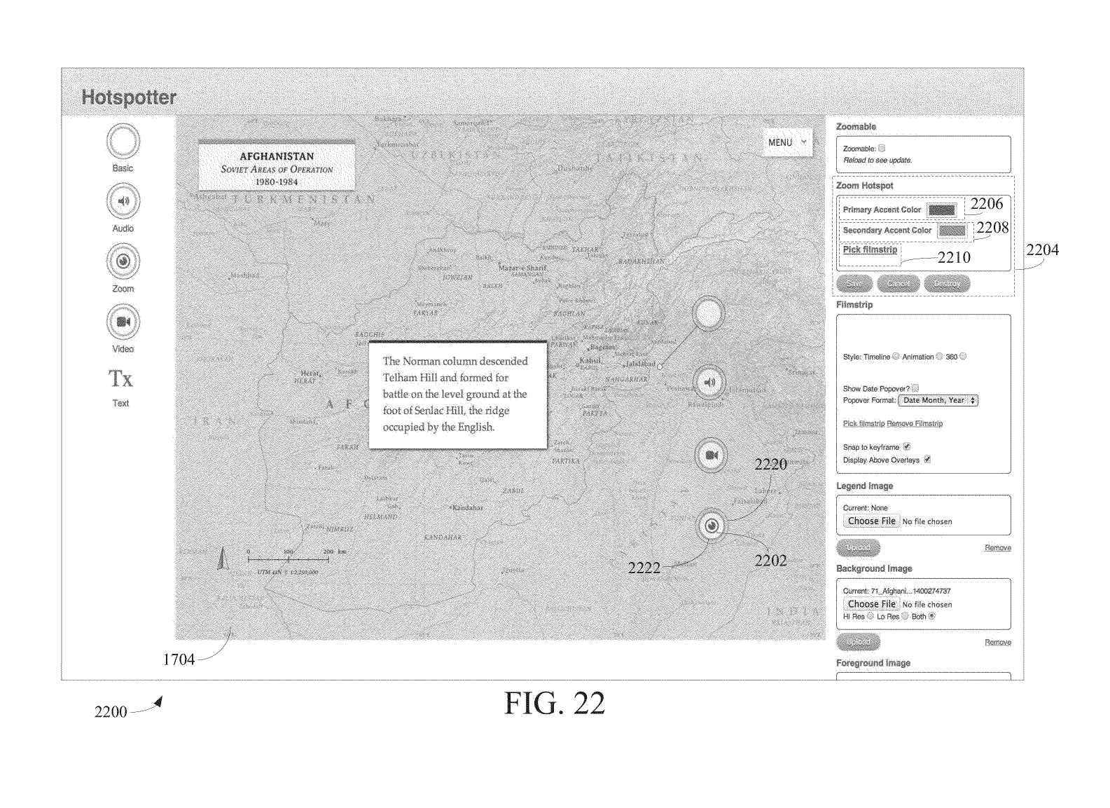

FIG. 22 depicts a GUI screen 2200 in which a developer has selected and placed a zoom hotspot interface element over a portion of background image 1704, thereby causing a zoom hotspot 2202 to be inserted over background image 1704. As shown in FIG. 22, a zoom hotspot detail editor 2204 is also presented as a result of inserting zoom hotspot 2202. Zoom hotspot 2202 is an interface element, which, when activated, causes a portion of an image on which it is inserted (i.e., a background image, a foreground image and/or an overlay) to be zoomed in or zoomed out (i.e., enlarged or reduced in size). Zoom hotspot detail editor 2204 may include an interface element 2206, an interface element 2208 and an interface element 2210. Interface element 2206 may comprise a “drop-down” menu, which, when activated, enables a developer to select a particular color for an outer ring of 2220 of zoom hotspot 2202. Interface element 2208 may comprise a “drop-down” menu, which, when activated, enables a developer to select a particular color for an inner ring 2222 of zoom hotpot 2202. Interface element 2210 may comprise a button, which, when activated, enables a developer to select a filmstrip that was previously loaded (e.g., via filmstrips section 410 of FIG. 4) to be played back upon activation of zoom hotspot 2202. For example, after a user (e.g., an end-user) has activated zoom hotspot 2202 and the associated zoom operation has completed, a filmstrip may be played back to the end-user.

An interactive toggle menu (e.g., interactive toggle menu 1730, as described above with respect to FIGS. 17 and 18) may also be added in response to selecting and placing a zoom hotspot interface element (if one has not already been added due to selecting and placing another hotspot interface element) over background image 1704. Additional details regarding zoom operations are described below in Subsection G.

In accordance with an embodiment, the hotspot detail editors (e.g., basic hotspot detail editor 1706, audio hotspot detail editor 1904, video hotspot detail editor 2004, text hotspot detail editor 2104 and zoom hotspot detail editor 2204, and the functionality provided thereby may be provided by hotspot detail editor views module 318 of interactive media object engine 302, as described above in reference to FIG. 3

In accordance with another embodiment, along with providing each of basic hotspot detail editor 1706, audio hotspot detail editor 1904, video hotspot detail editor 2004, text hotspot detail editor 2104 and zoom hotspot detail editor 2204 to the developer in response to selecting and placing a respective hotspot interface element over an image (e.g., background image, foreground image and/or overlays), each of basic hotspot detail editor 1706, audio hotspot detail editor 1904, video hotspot detail editor 2004, text hotspot detail editor 2104 and zoom hotspot detail editor 2204 may be provided in response to selecting a corresponding hotspot that has been inserted over an image.

E. Overlays

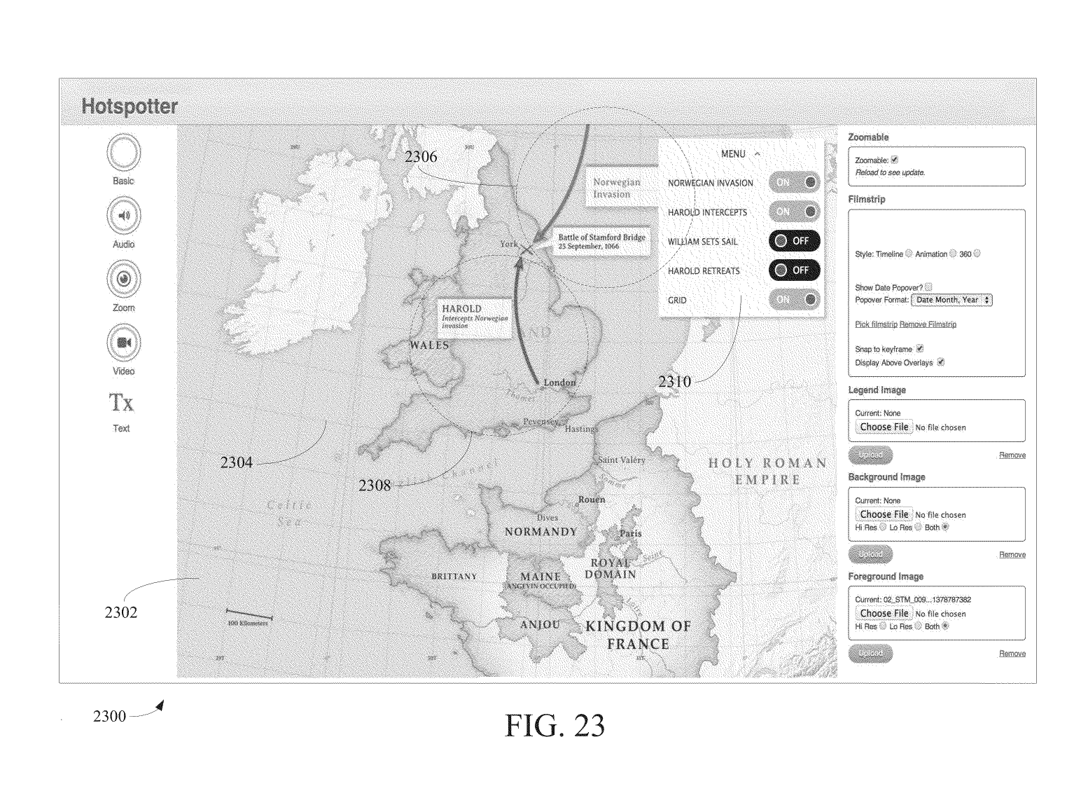

As described above with respect to FIG. 4, a developer is enabled to insert overlays over a background image or a foreground image using interface element 418 included in overlays section 412. FIG. 23 depicts a GUI screen 2300 in which multiple overlays have been inserted over a background image 2302. Background image 2302 may be uploaded in a manner similar to that described above in reference to background image 1002 of FIG. 10. As shown in FIG. 23, overlay 2304, overlay 2306 and overlay 2308 are inserted over background image 2302. Overlay 2304 comprises grid lines for the map depicted by background image 2302. Overlay 2306 comprises an arrow and a text box that describe the Norwegian invasion of York, and overlay 2308 comprises an arrow and a text box that describe King Harold's interception of the Norwegian invasion. An interactive toggle menu 2310 may also be added in response to inserting overlay(s) 2304, 2306 and 2308 over background image 2302, which enables a user (e.g., an end-user) to activate or de-activate a particular overlay (in a similar manner to that described above with respect to interactive toggle menu 1730 of FIGS. 17 and 18). In accordance with an embodiment, interactive toggle menu 1730 and/or interactive toggle menu 2310 may include toggle switches for both hotspots and overlays, although embodiments are not limited in this respect.

In accordance with an embodiment, the functionality that inserts an overlay over a background image and/or a foreground image and/or provides the interactive toggle menu may be provided by overlay controller 310 of interactive media object engine 302 as described above in reference to FIG. 3.

F. Filmstrips

As described above, a filmstrip may be a set of images (e.g., frames) that compose an animation when played back. In accordance with an embodiment, the animation is controlled by filmstrip controller 334 of interactive media object engine 302, as described above in reference to FIG. 3.

As described above with respect to FIG. 4, a developer may be enabled to upload a filmstrip using interface element 416 included in filmstrips section 410. With reference to FIG. 7, once uploaded, a developer may be enabled to insert one or more filmstrips over a background image, a foreground image and/or an overlay using filmstrip section 708.

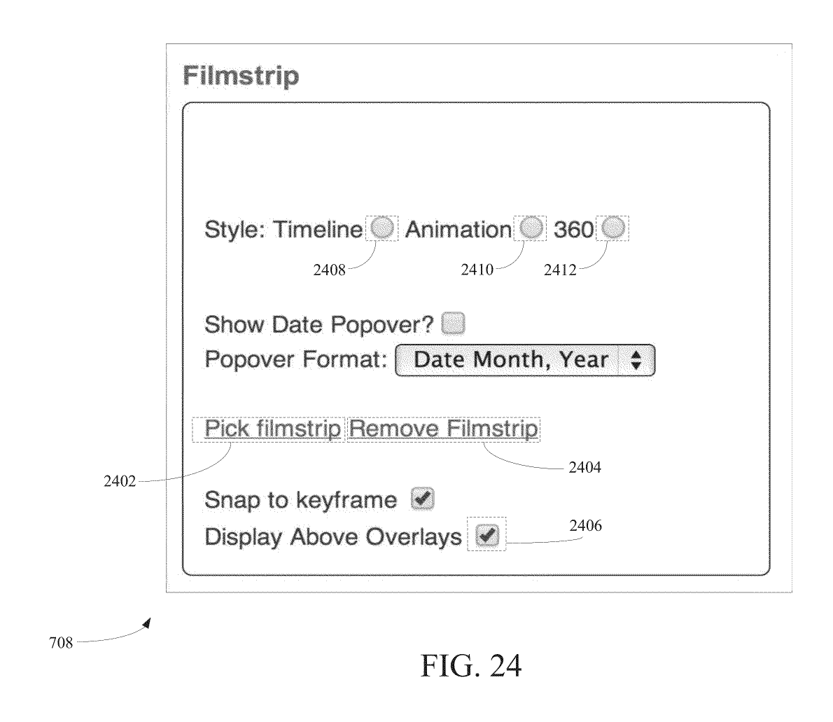

FIG. 24 shows an enlarged view of filmstrip section 708. As shown in FIG. 24, filmstrip section 708 may include an interface element 2402 and an interface element 2404. Interface element 2402 may be a button, which, when activated, may cause a dialog box to appear (not shown) that enables a developer to select a filmstrip to insert over a background image, a foreground image, and/or an overlay. Interface element 2404 may comprise a button, which, when activated, enables a developer to remove a previously loaded filmstrip.

Once a filmstrip is selected, the filmstrip is inserted over a background image and/or a foreground image. A filmstrip may also be inserted over an overlay. For example, as further shown in FIG. 24, filmstrip section 708 may also include an interface element 2406. Interface element 2406 may comprise a check box, which, when checked, causes the filmstrip to be inserted over one or more overlays.

In accordance with certain embodiments, a developer may be enabled to configure various features of the filmstrip. For example, a developer may be enabled to configure a control mechanism used for playback of the filmstrip, designate one or more frame(s) of the filmstrip to be keyframes, configure these keyframes to display additional information (e.g., ticker information or an outline showing keyframe data) and/or popovers that display information above the control mechanism that pertains to the current frame being played back. Each of these features are described below.

In accordance with an embodiment, the functionality provided by filmstrip section 708 may be provided by filmstrip editor 326 of interactive media object engine 302 as described above in reference to FIG. 3.

1. Control Mechanisms

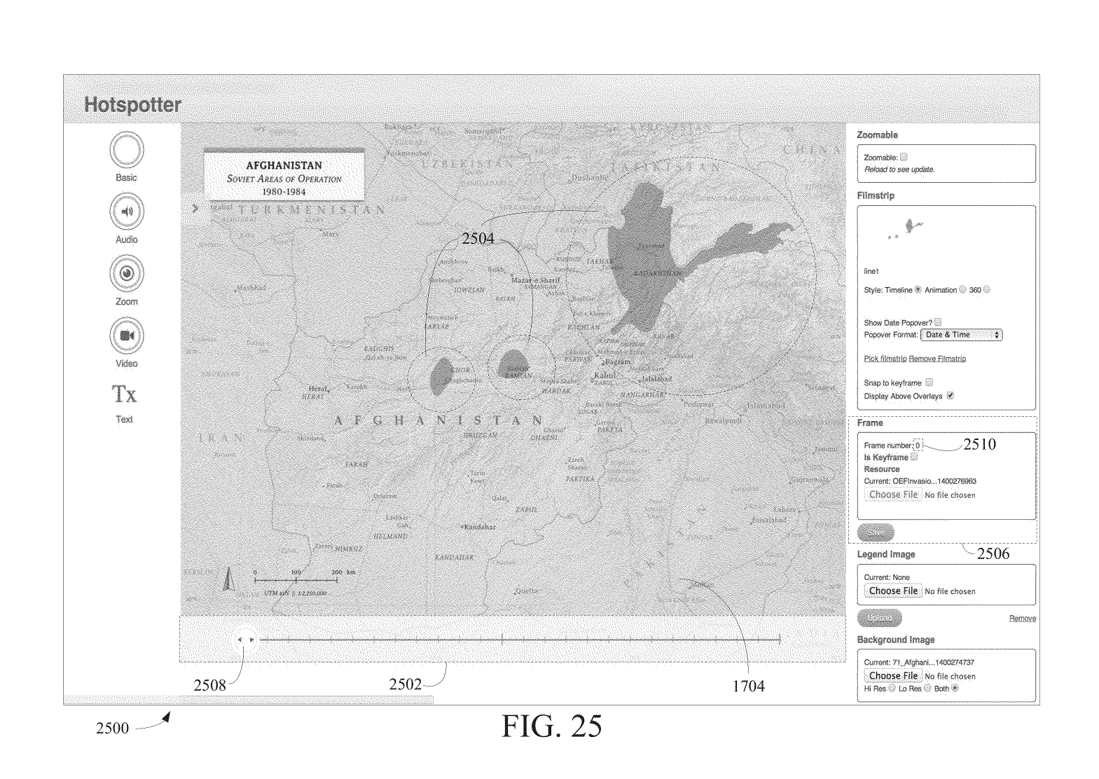

When a filmstrip is inserted over a background image, foreground image and/or overlay(s), a control mechanism that is used to control the playback of the filmstrip is also inserted. A developer may be enabled to select the style of the control mechanism. For example, as shown in FIG. 24, filmstrip section 700 may further include an interface element 2408, an interface element 2410 and an interface element 2412, which enable a developer to select a particular style for the control mechanism. For example, as shown in FIG. 24, interface element 2408 may comprise a radio button, which, when activated, causes a timeline style control mechanism to be inserted. Interface element 2410 may comprise a radio button, which, when activated, causes an animation style control mechanism to be inserted. Interface element 2412 may comprise a radio button, which, when activated, causes a 360-degree style control mechanism to be inserted. Each of these styles are described below with reference to FIGS. 25, 26 and 27, respectively.

a. Timeline Style Control Mechanism

FIG. 25 shows a GUI screen 2500 that includes an example of a timeline style control mechanism 2502 that can be used to play back an inserted filmstrip 2504. As shown in FIG. 25, filmstrip 2504 may cover background image 1704 in its entirety, although embodiments are not limited in this respect. GUI screen 2500 also includes a frames section 2506, which is also displayed in response to the insertion of filmstrip 2504. As shown in FIG. 25, timeline style control mechanism 2502 may include a slider 2508 that a user (e.g., an end-user) can drag along timeline style control mechanism 2502 to change which frame of filmstrip 2504 is being displayed. An end-user may also change the location of slider 2508 by selecting a particular section of timeline style control mechanism 2502. The current frame number (e.g., frame number 2510) may be displayed in frame section 2506. As shown in FIG. 25, the location of slider 2508 corresponds to frame ‘0.’

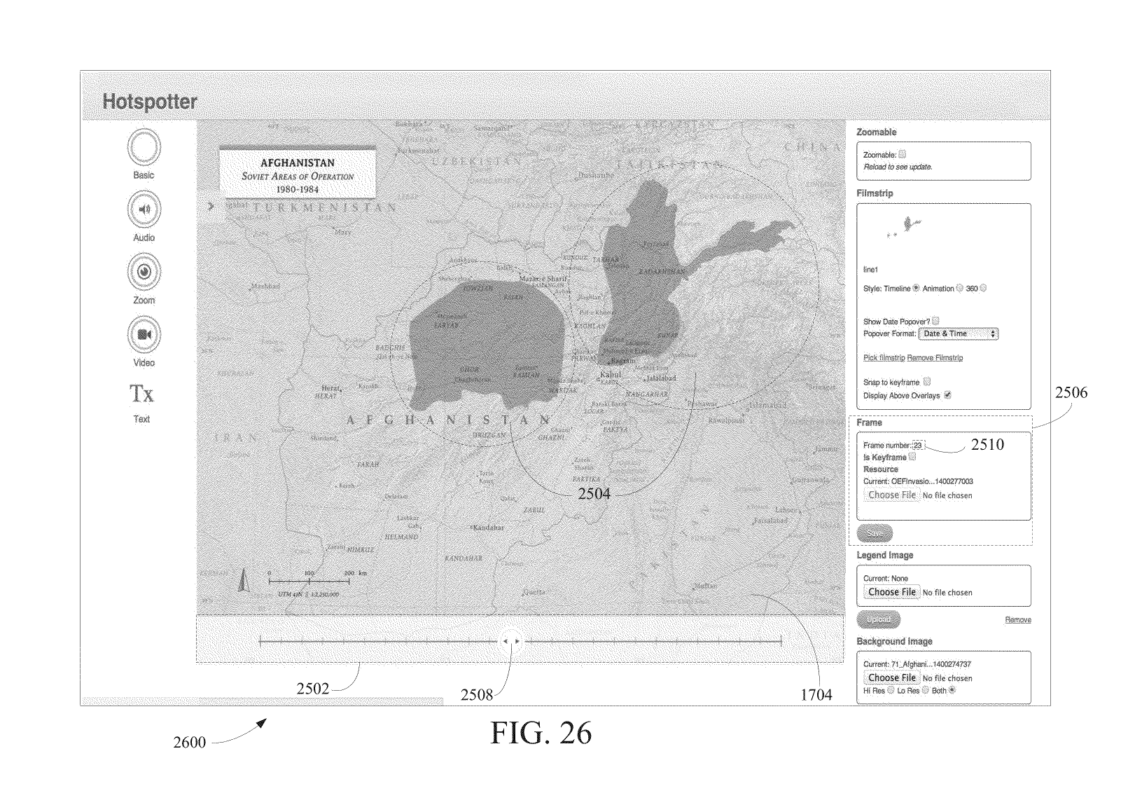

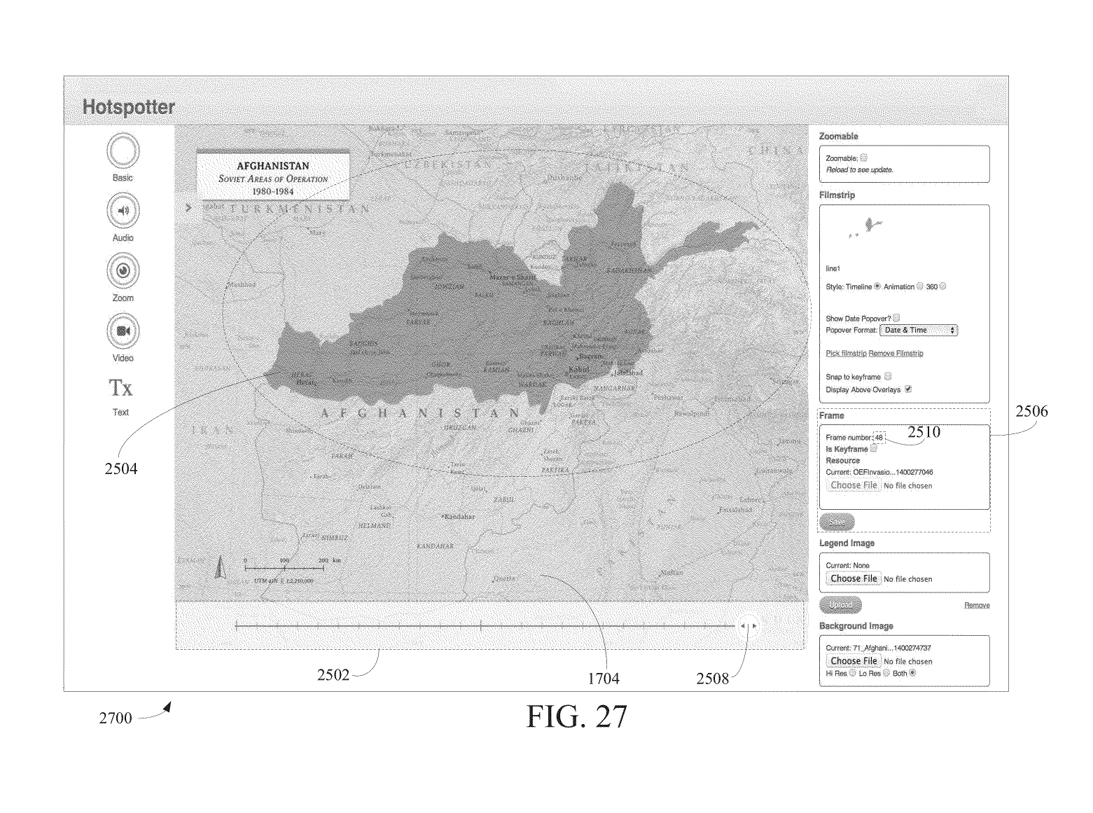

FIGS. 26 and 27 show GUI screen 2600 and 2700, respectively, that depict slider 2508 at different positions along timeline style control mechanism 2502 that correspond to different frames of filmstrip 2504. For example, referring to FIG. 26, the position of slider 2508 corresponds to frame 23, as indicated by frame number 2510. Referring to FIG. 27, the position of slider 2508 corresponds to frame 48, as indicated by frame number 2510.

In accordance with an embodiment, the functionality provided by timeline style control mechanism 2502 and/or slider 2508 may be provided by timeline controls module 332 of interactive media object engine 302 as described above in reference to FIG. 3.

b. Animation Style Control Mechanism

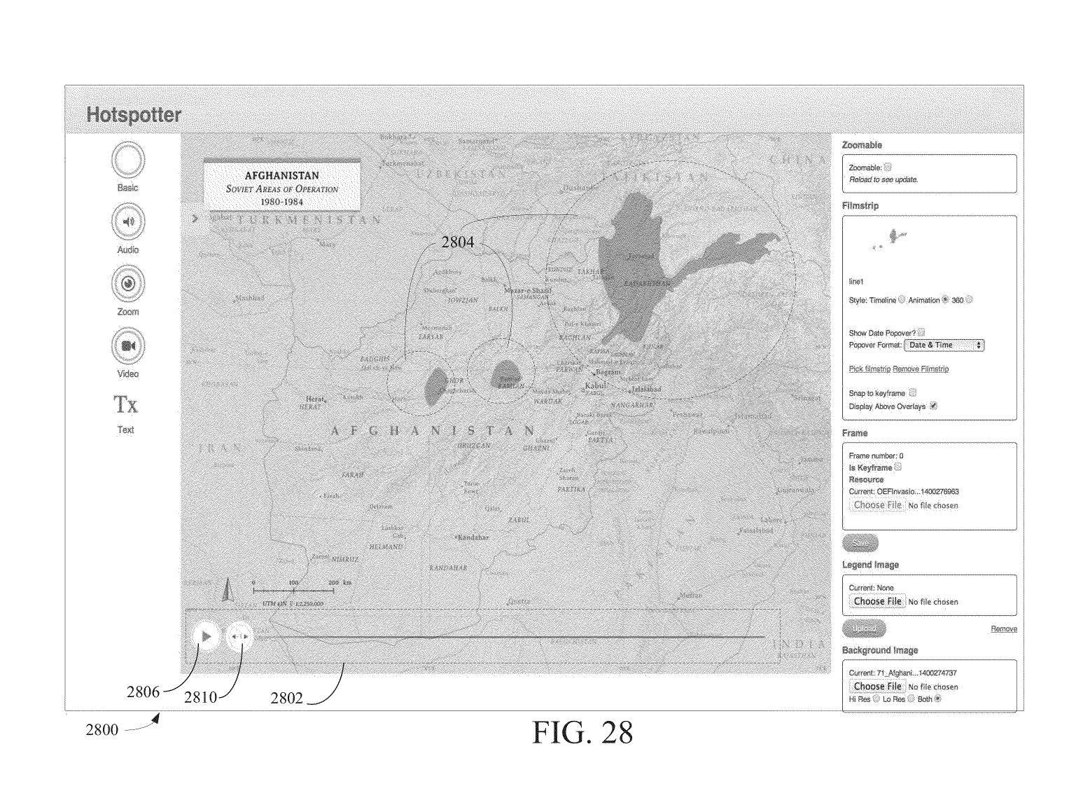

FIG. 28 shows a GUI screen 2800 that includes an example of an animation style control mechanism 2802 that can be used to play back an inserted filmstrip 2804. As shown in FIG. 28, animation style control mechanism 2802 includes a play button 2806 and a slider 2810. Play button 2806, when activated, causes a filmstrip to be played back automatically. Play button 2806, when deactivated, causes a filmstrip to be paused. In accordance with an embodiment, an end-user may also drag slider 2810 across animation style control mechanism 2802 to change which frame of filmstrip 2804 is being displayed. In accordance with another embodiment, an end-user may also change the location of slider 2810 by selecting a particular section of animation style control mechanism 2802.

In accordance with an embodiment, the functionality provided by animation style control mechanism 2802 may be provided by timeline controls module 332 of interactive media object engine 302 as described above in reference to FIG. 3.

c. 360-degree Style Control Mechanism

A 360-degree style control mechanism enables an end-user to control playback of a filmstrip by “click- and dragging” a mouse, dragging a stylus, swiping a finger, etc. across the GUI screen. A 360-degree style control mechanism may be applicable for a filmstrip that depicts a 3D model. In such a case, an end-user can effectively rotate the 3D-model using the 360-degree style control mechanism.

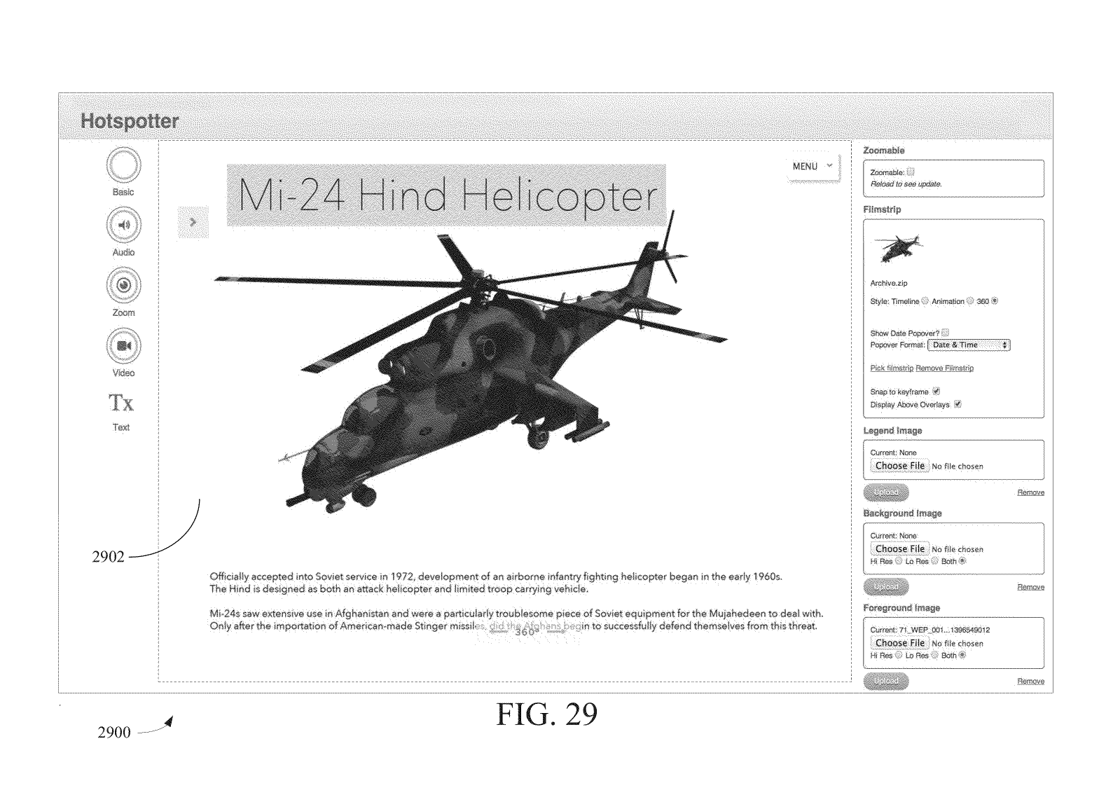

FIG. 29 shows a GUI screen 2900 that includes an example of a 360-degree style control mechanism used to play back an inserted filmstrip 2902. Filmstrip 2902 comprises a set of frames, wherein each frame depicts a different perspective view of a 3D model (e.g., the 3D helicopter model shown in FIG. 29), wherein each perspective view is from a different angle. An end-user may be enabled to control the frame being shown by “click- and dragging” a mouse, dragging a stylus, swiping a finger, etc. For example, if an end-user “clicks-and-drags,” drags a stylus, swipes a finger, etc. from left to right, the frames of filmstrip 2902 may be cycled in a sequential order, thereby effectively rotating the helicopter in a counter-clockwise manner along a vertical axis If an end-user “clicks-and-drags,” drags a stylus, swipes a finger, etc. from right to left, the frames of filmstrip 2902 may be cycled in a reverse sequential order (i.e., the frames are played backward), thereby effectively rotating the helicopter in a counter-clockwise manner along a vertical axis.

2. Keyframes

A developer may be enabled to designate certain frame(s) of a filmstrip as keyframe(s) and configure these keyframe(s) to provide additional information when these keyframe(s) are displayed. A developer may be enabled to designate and configure a keyframe using a frame section that appears when interacting with a control mechanism.

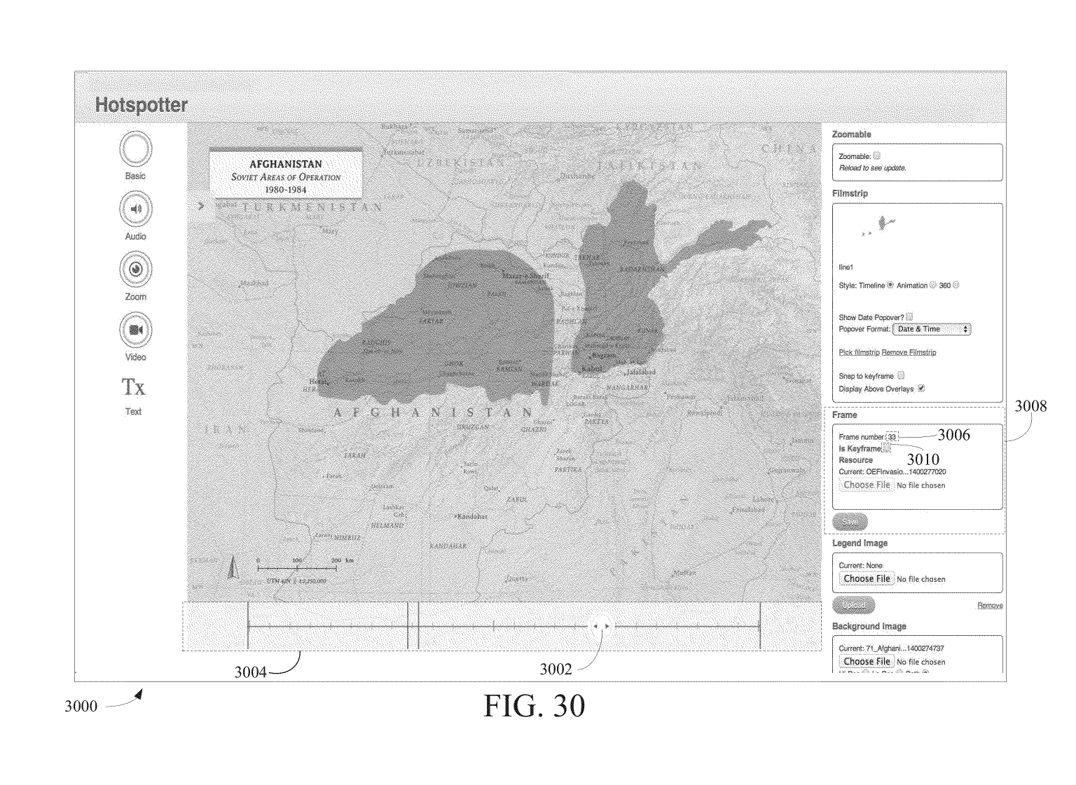

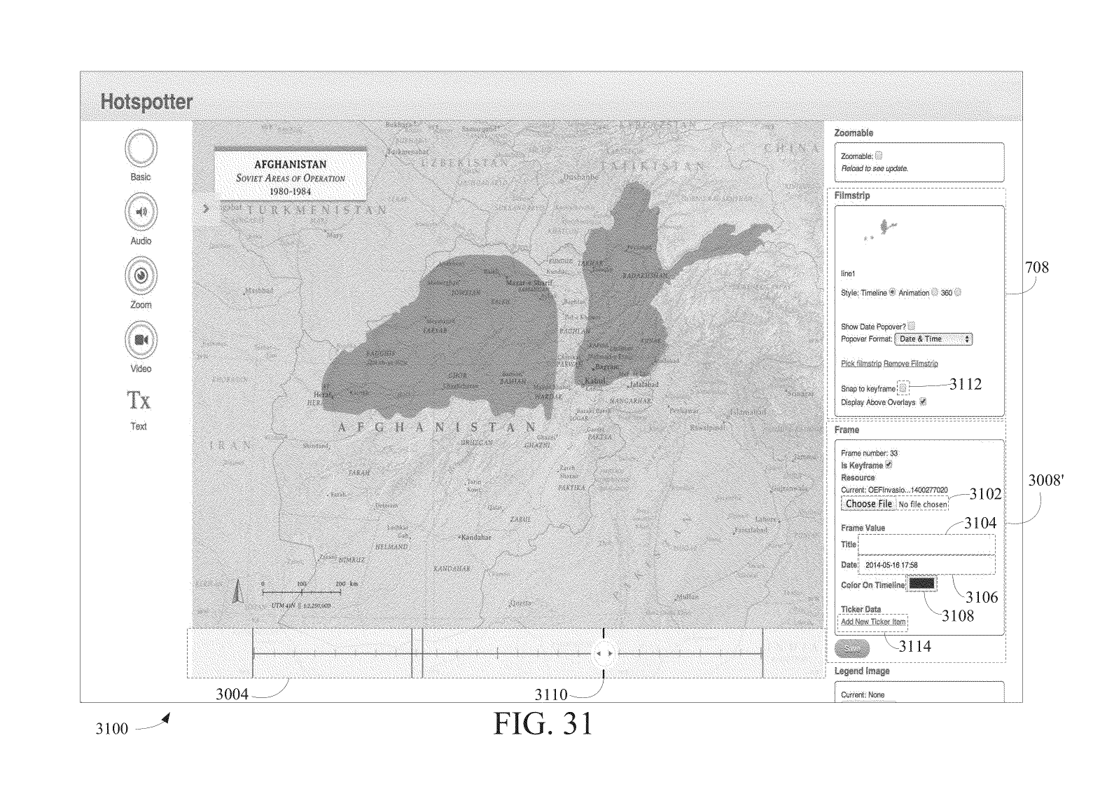

FIGS. 30 and 31 depict GUI screens 3000 and 3100, respectively, that illustrate the designating and configuring of a keyframe. As shown in FIG. 30, a slider 3002 of a timeline style control mechanism 3004 is positioned at frame 33 (as indicated by a frame number 3006 of a frame section 3008). Frame section 3008 may be displayed by the GUI in response to a developer selecting a frame using slider 3002.

As further shown in FIG. 30, frame section 3008 includes an interface element 3010. Interface element 3010 may comprise a checkbox, which, when checked, enables a developer to designate the currently-displayed frame as a keyframe. As shown in FIG. 31, upon designating the frame as a keyframe, a keyframe indicator 3110 is displayed on timeline style control mechanism 3004. Frame section 3008 is also expanded to show configurability options for the newly-designated keyframe. The expanded frame section is denoted expanded frame section 3008′ in FIG. 31.

Expanded frame section 3008′ may include an interface element 3102, an interface element 3104, an interface element 3106 and an interface element 3108. Interface element 3102 may comprise a button, which, when activated, enables a developer to load a new frame to replace a currently-displayed frame. In accordance with an embodiment, this functionality is provided by frame uploader module 324 of interactive media object engine 302 as described above in reference to FIG. 3.

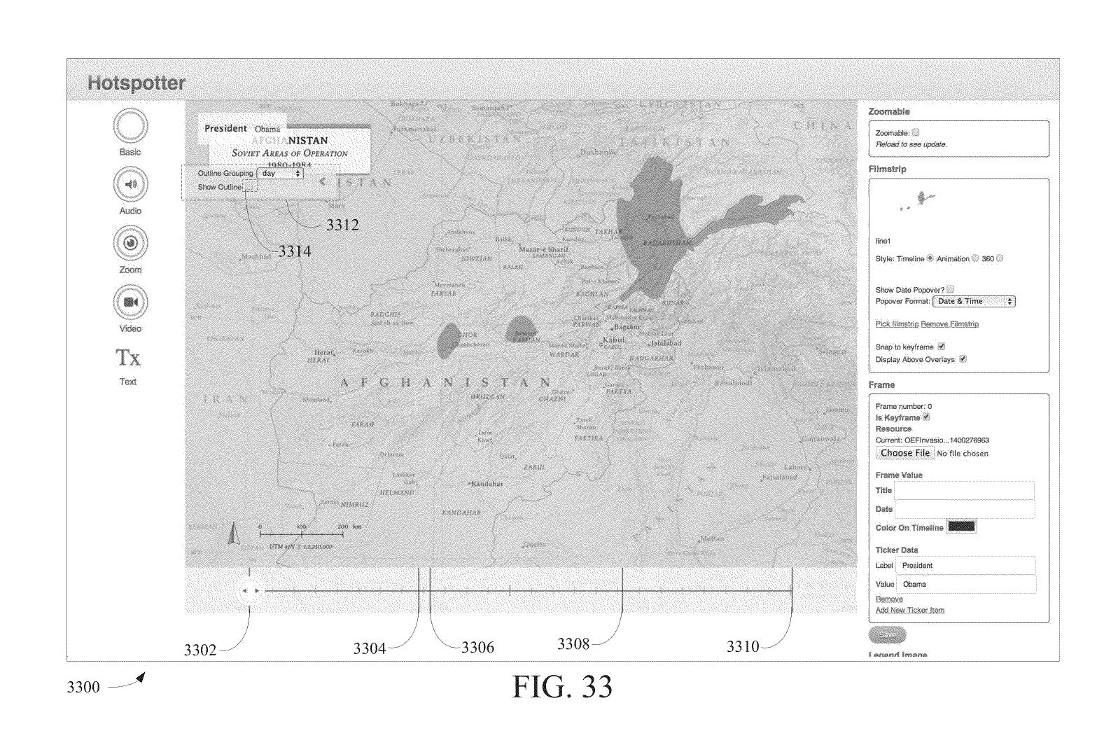

Interface element 3104 may comprise a text box in which a developer can enter a title for the keyframe. Interface element 3106 may comprise a text box in which a developer can enter a date for the keyframe. As will be described below with respect to FIG. 33, the keyframe title and date may be optionally displayed in an outline form. Interface element 3108 may comprise a “pull-down” menu, which, when activated, enables a developer to select a color for keyframe indicator 3110.

In accordance with an embodiment, a developer may also be enabled to insert hotspots for designated keyframe(s) that only appear when those keyframes are displayed. Hotspots may be inserted in a manner described above with respect to Subsection D.

In accordance with another embodiment, a developer may configure slider 3010 to snap to keyframes. For example, as shown in FIG. 31, filmstrip section 708 may further include an interface element 3112. Interface element 3112 may comprise a check box, which, when checked, causes slider 3010 to snap to keyframes. For example, as an end-user drags slider 3010 across timeline style control mechanism 3004, slider 3010 may snap to the nearest keyframe upon an end-user releasing slider 3010. In accordance with an embodiment in which an animation style control mechanism is used, the slider may be configured to pause on keyframes if interface element 3112 is activated. That is, the keyframes may serve as stoppings points during playback of a filmstrip.

It is noted that while FIGS. 30 and 31 describe keyframe designation and configuration with respect to a timeline style control mechanism, keyframe designation and configuration may also be performed in a similar manner using any other style of control mechanism.

In accordance with an embodiment, the functionality provided by frame sections 3008 and 3008′ may be provided by frame detail editor module 332 of interactive media object engine 302, as described above in reference to FIG. 3.

3. Ticker Information

In accordance with an embodiment, a developer may be enabled to display time sensitive information pertaining to a particular keyframe. In accordance with an embodiment in which the interactive media object is being developed for a digital book regarding warfare, this information may include, but is not limited to, troop strength for a particular date, an amount of national resources available at a particular date, the sitting president for a particular date, etc. This information may be referred to as ticker information.

A developer may be enabled to display ticker information using a frame section of a GUI screen. For example, with continued reference to FIG. 31, expanded frame section 3008′ of GUI screen 3100 may further include an interface element 3114. Interface element 3114 may comprise a button, which, when activated causes expanded frame section 3008′ to be further expanded to include options for configuring ticker information.

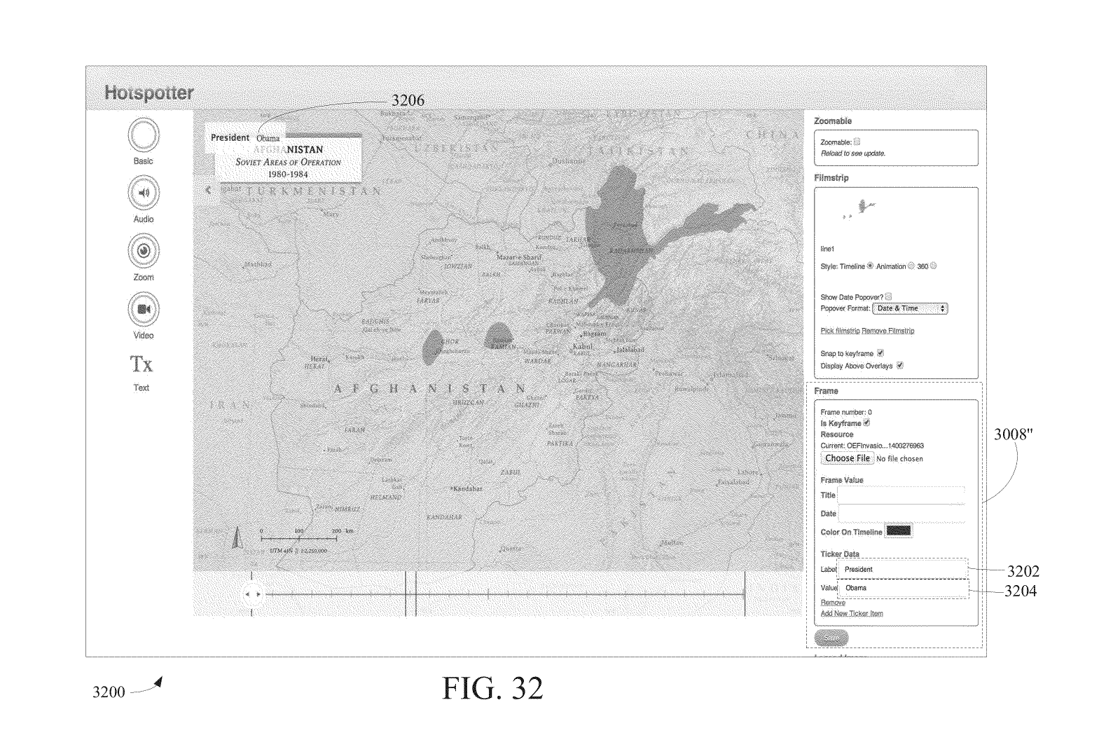

FIG. 32 depicts a GUI screen 3200 that includes a further expanded frame section 3008″, in accordance with embodiments. As shown in FIG. 32, further expanded frame section 3008″ includes an interface element 3202 and an interface element 3204. Interface element 3202 may comprise a text box in which a developer can enter a label (e.g., “President”) in association with certain ticker information. Interface element 3204 may comprise a text box in which a developer can enter a value (e.g., “Obama”) in association with the ticker information. A resulting ticker 3206 may be displayed in the upper left hand corner of the GUI, as shown in FIG. 32. However, embodiments are not limited in this respect.

4. Outlines

In accordance with an embodiment, keyframe data (e.g., the keyframe time and date that is specifiable via interface element 3104 and 3106, as shown in FIG. 31) may be organized into a user-toggleable outline that is displayable to the user (e.g., a developer or an end-user). The outline may be presented upon a developer designating a frame as keyframe.

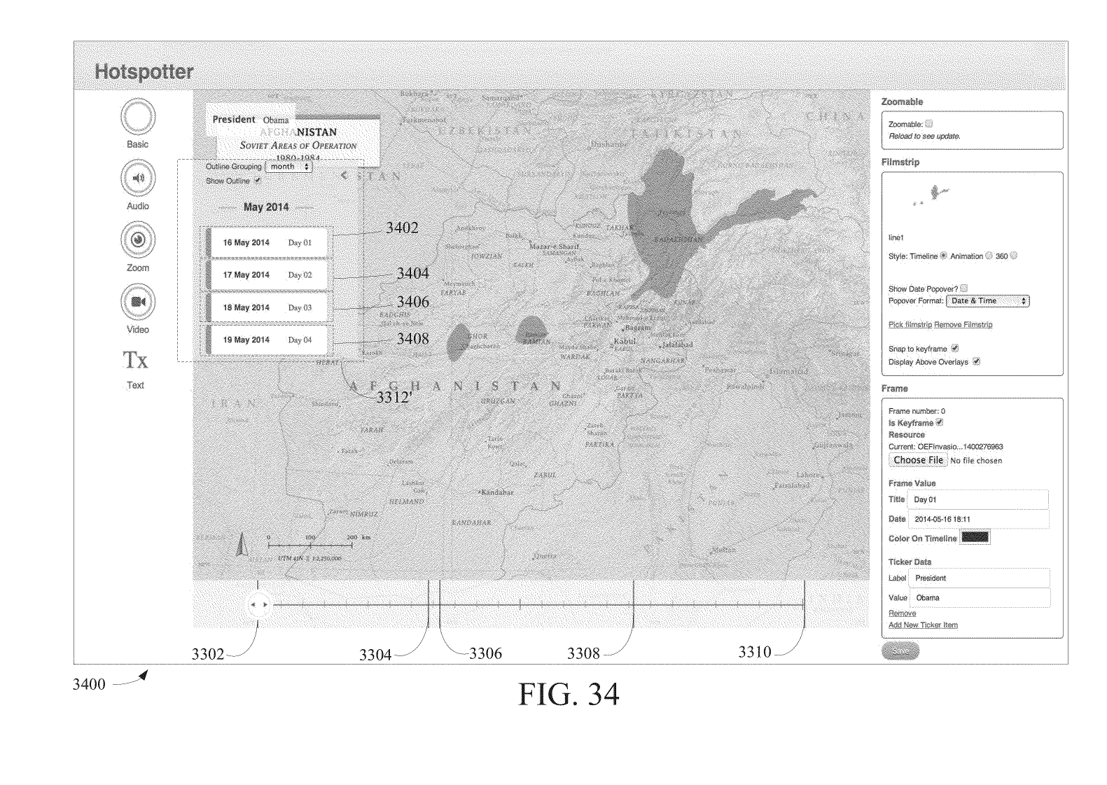

FIGS. 33 and 34 depict GUI screens 3300 and 3400, respectively, showing a user-toggleable outline, in accordance with embodiments. As shown in FIG. 33, five frames have been designated as keyframes, as indicated by keyframe indicators 3302, 3304, 3306, 3308 and 3310. Accordingly, GUI screen 3300 has been updated to display outline element 3312. It is noted that GUI screen 3300 may be updated to display outline element 3312 in response to the designation of a single keyframe. Outline element 3312 may include an interface element 3314. Interface element 3314 may comprise a check box, which, when checked, causes outline element 3312 to be expanded.

FIG. 34 shows an expanded outline element 3312′. As shown in FIG. 34, each entry in expanded outline element 3312′ corresponds to a keyframe. For example, entry 3402 corresponds to keyframe 3302, entry 3404 corresponds to keyframe 3304, entry 3406 corresponds to keyframe 3306 and entry 3408 corresponds to keyframe 3308. An end-user may be enabled to view entry 3410 (which corresponds to keyframe 3310) by scrolling down within expanded outline element 3312′. Each entry displays the keyframe title and/or keyframe data for the corresponding keyframe. Each entry may also be interactive such that an end-user may cause a keyframe of the filmstrip to be displayed by selecting a corresponding entry included in expanded outline element 3312′.

5. Popovers

In accordance with an embodiment, a slider (e.g., slider 2508 and slider 2810, as shown in FIGS. 25 and 28, respectively) may be supplemented with additional information (e.g., a date) associated with the frame for which the position of the slider corresponds. The additional information may in a display element provided proximate to (e.g., above the) slider. The display element may be referred to as a “popover.” A developer may enable a popover by activating an interface element included in filmstrip section 708.

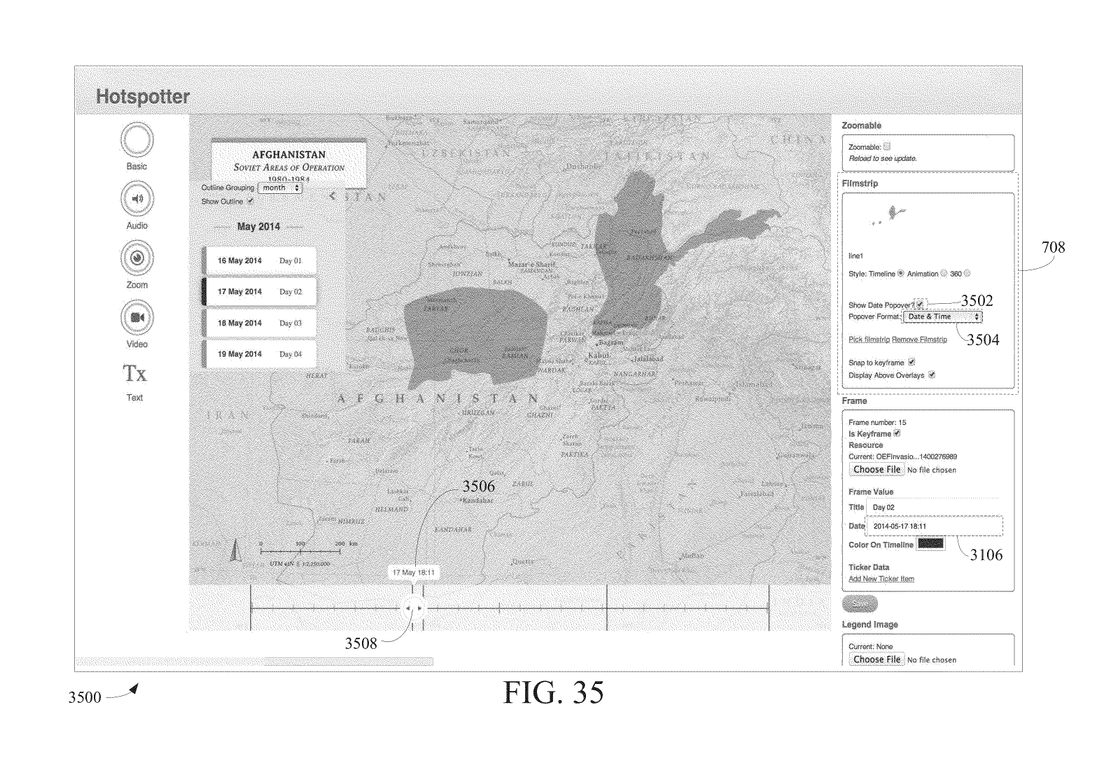

FIG. 35 depicts a GUI screen 3500 showing the activation and display of a popover 3506. As shown in FIG. 35, filmstrip section 708 includes an interface element 3502 and an interface element 3504. Interface element 3502 may comprise a check box, which, when checked, causes popover 3506 to be displayed. Interface element 3504 may comprise a “drop-down” menu, which, when activated, enables a developer to select a display format (e.g., a date format (“Date Month, Year”, “DD/MM/YY,” etc.) for the popover. The date used to populate popover 3506 may be provided by the date specified in interface element 3106, as described above with respect to FIG. 31. As shown in FIG. 35, popover 3506 is positioned above slider 3508)

6. Filmstrip Module

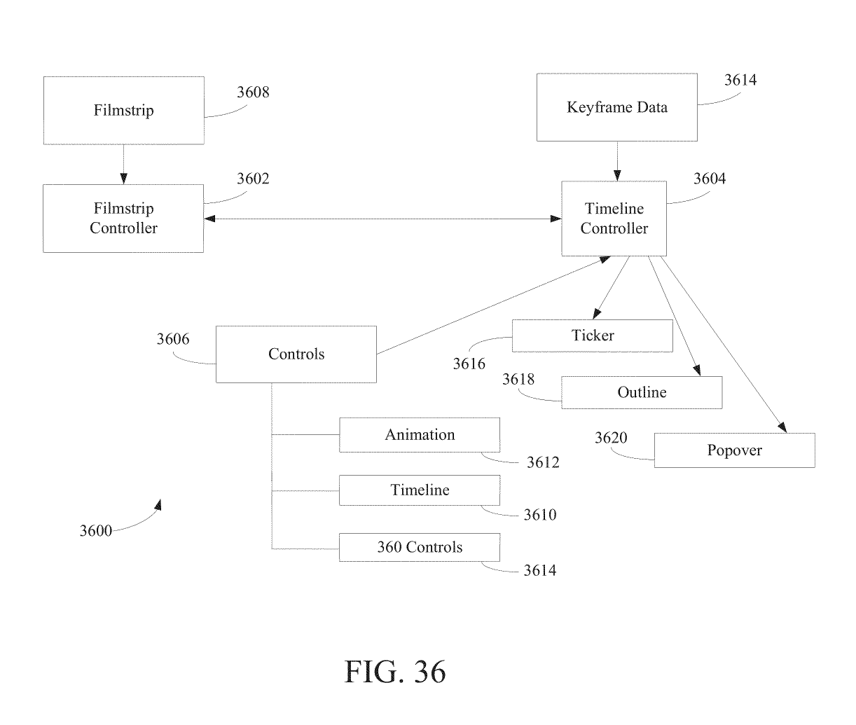

Each of the above-described features in Section F may be implemented via filmstrip module 320, as described above in reference to FIG. 3. Filmstrip module 320 is described in more detail below in reference to FIG. 36.

FIG. 36 shows a block diagram of a filmstrip module 3600. Filmstrip module 3600 may be an example of filmstrip module 320. As shown in FIG. 36, filmstrip module 3600 may include a filmstrip controller module 3602, a timeline controller module 3604, and a controls module 3606. Filmstrip controller module 3602 may be an example of filmstrip controller module 334 (as shown in FIG. 3), timeline controller module 3604 may be an example of timeline controller module 330 (as shown in FIG. 3) and controls module 3606 may be an example of timeline controls module 332 (as shown in FIG. 3),

Filmstrip controller module 3602 may be configured to show and hide the appropriate frames of a filmstrip (e.g., filmstrip 3608) during playback to create an animation. Filmstrip controller module 3602 may also be configured to play, pause, jump and/or snap to specific frames of filmstrip 3608 based on input provided via timeline controller 3604. Filmstrip controller module 3602 may further be configured to hold a play state (i.e., remain on a paused, jumped to, or snapped to frame). Filmstrip controller module 3602 may provide the play state (play, stop or pause) and a current frame number of filmstrip 3608 to timeline controller module 3604.

Timeline controller module 3604 may be configured to provide a control mechanism (e.g., via controls module 3606) that allow a user (e.g., a developer and/or end-user) to interact with filmstrip 3608. Controls module 3606 may comprise a play or pause button and/or a slider (as described above with respect to FIGS. 25-29). The type of control mechanism presented may be configurable by the developer. The types of control mechanisms include a timeline style animation control mechanism 3610 (as described above with respect to FIGS. 25-27), an animation style control mechanism 3612 (as described above with respect to FIG. 28) and a 360 degree style control mechanism 3614 (as described above with respect to FIG. 29). In accordance with an embodiment, timeline style control mechanism 3610 and/or animation style control mechanism 3612 may be provided as a jQuery Slider.

Timeline controller module 3604 may be configured to detect input received by a user via controls module 3606 and provide a notification to filmstrip controller module 3602 specifying a frame to be displayed.

Timeline controller module 3604 may be further configured to cause additional information (e.g., keyframe data 3614) for each keyframe to be displayed. Examples of keyframe data 3614 include a title and date associated with they keyframe (as described above with respect to FIG. 31). The additional information may be provided as a ticker 3616 (as described above with respect to FIG. 32), an outline 3618 (as described above with respect to FIGS. 33 and 34), and/or as a popover 3620 (as described above with respect to FIG. 35).

For example, filmstrip controller module 3602 may provide a notification to timeline controller module 3604 that indicates the current frame number. Timeline controller module 3604, using keyframe data 3614, may determine that the current frame is a keyframe. In response, timeline controller module 3604 may cause keyframe data 3614 to be displayed via ticker 3616, outline 3618 and/or popover 3620.

G. Zoom Features

In accordance with an embodiment, a user (e.g., an end-user) may be enabled to zoom into a portion of a background image, foreground image and/or overlays. As described above with reference to FIG. 22, a developer may be enabled to designate a portion of an interactive media object into which a developer is able to zoom using a zoom hotspot. Alternatively, a developer may be enabled to designate an entire background image, foreground image and/or overlay as being zoomable.

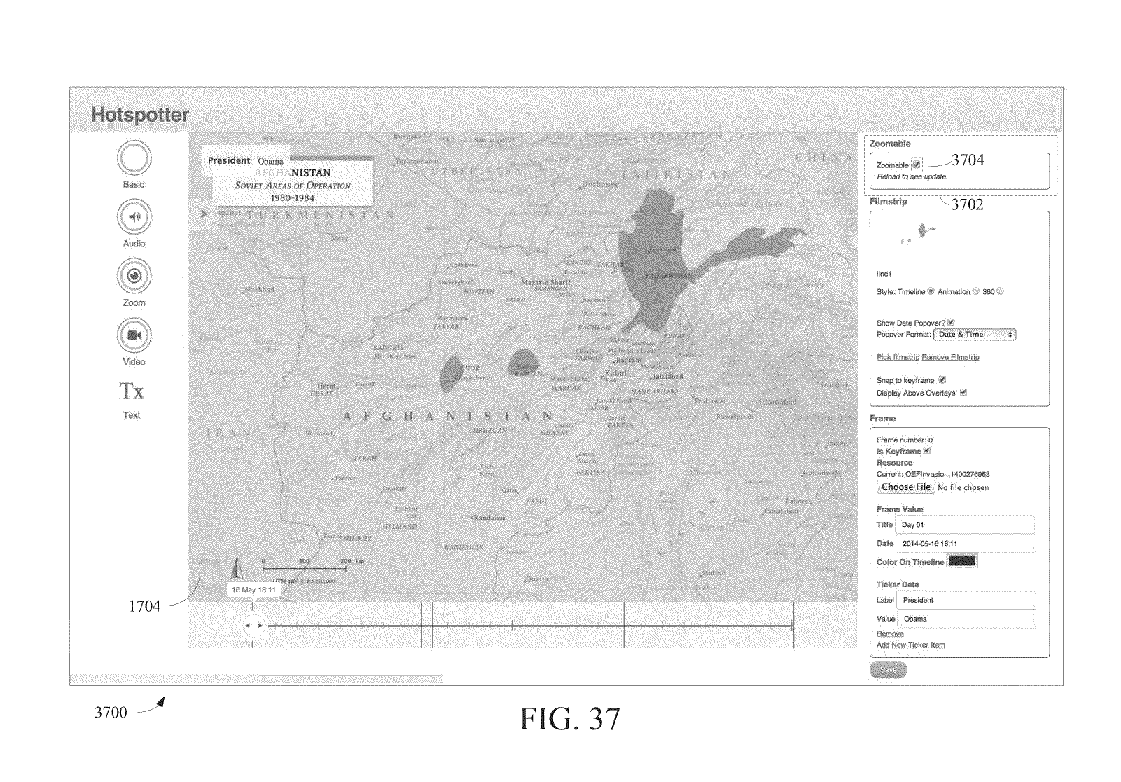

For example, FIG. 37 depicts a GUI screen 3700 in which a developer is enabled to designate an entire background image as being zoomable. As shown in FIG. 37, GUI screen 3700 includes a zoom section 3702. Zoom section 3702 includes an interface element 3704. Interface element 3704 may comprise a check box, which, when checked, may cause background image 1704 to be zoomable.

An end-user may zoom into any portion of background image 1704 by providing user input (e.g., pinching out, tapping on a particular portion of background image 1704, double-clicking on a particular portion of background image 1704 using an input device (e.g., a stylus, mouse, etc.)).

When zooming into an overlay, the overlay may be scaled and repositioned to give the illusion that the end-user is moving into the image at that location. When zooming into a background image, the background image may only slightly scale and stay centered, thereby giving the illusion of depth in the scene depicted by the background image. When zooming into a foreground image, the foreground image may be scaled in, and the foreground image may be repositioned to center on the position selected for zooming

In accordance with an embodiment, upon zooming in, the image (i.e., the background image, the foreground image, or the overlay) being zoomed into may be replaced by a tiled, higher resolution version of that image. This may be done to prevent a jarring transition. In accordance with such an embodiment, when uploading a foreground image or background image (as described above with respect to Subsections A and B, respectively), a developer may select the option to upload both a high resolution version and a low resolution version of the image.

### IV. Example Method for Enabling a User to Develop an Interactive Media Object

A user (e.g., a developer) may be enabled to develop an interactive media object suitable for display on a computer device in various ways, in embodiments.

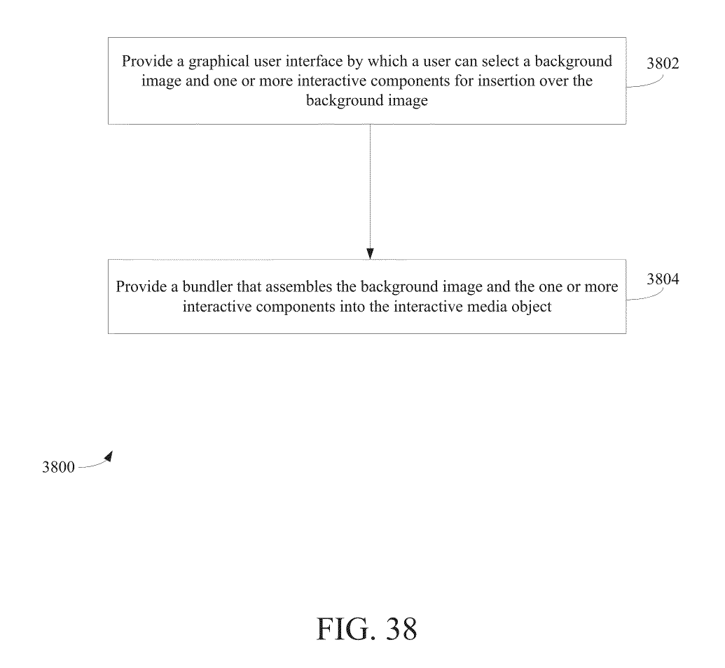

FIG. 38 depicts a flowchart 3800 of an example method for enabling a user to develop an interactive media object, according to an example embodiment. The method of flowchart 3800 will be described in reference to elements of system 100. However, it is noted that the method is not limited to that implementation.

As shown in FIG. 38, the method of flowchart 3800 begins at step 3802. In step 3802, a GUI is provided by which a user can select a background image and one or more interactive components for insertion over the background image. For example, with reference to FIG. 1, interactive media object development engine 102 provides user interface 104 by which a user can select a background image and interactive component(s) for insertion over the background image. The interactive component(s) may include at least one of a hotspot that causes multimedia content to be displayed over the background image when activated, an overlay component that causes an image to be displayed over the background image when activated and causes the image to be hidden when deactivated, a foreground image that is displayed over the background image, and a filmstrip that is displayed over the background image and that comprises a set of images that compose an animation when played back.

In accordance with an embodiment, the interactive media object comprises an interactive media object that is suitable for embedding in a digital book.

In accordance with another embodiment, the GUI further comprises a hotspot detail editor that enables the user to configure one or more parameters of the hotspot. The parameter(s) may comprise multimedia content to be displayed over the background image when the hotspot is activated.

In accordance with a further embodiment, the GUI further comprises a frame detail editor that enables the user to designate one or more images of the filmstrip as one or more respective keyframes. The respective keyframe(s) serve as stopping points during playback of the filmstrip.

In accordance with yet another embodiment, a filmstrip module is provided. The filmstrip module may include a timeline controller module and a controls module. The timeline controller module may causes a ticker to be displayed for each of the respective keyframe(s). The ticker may display time sensitive information associated with each of the respective keyframe(s). The timeline controller module may further cause data associated with each of the respective keyframe(s) to be displayed as a list. The data may comprise at least one of a date and time associated with each of the respective keyframe(s). The controls module may enable the user to select a particular image of the set of images for viewing or configuring.

In accordance with a further embodiment, a zoom module is provided. The zoom module may enable the user to perform a zoom operation on at least a portion of the at least one of the background image, the foreground image, and the overlay.

In accordance with yet another embodiment, the GUI further comprises an interface element that, when activated, provides an interactive preview of the interactive media object within the graphical user interface.

At step 3804, a bundler is provided that assembles the background image and the one or more interactive components into the interactive media object. For example, as shown in FIG. 1, bundler 108 is configured to assemble the background image and the interactive component(s) into the interactive media object.

### V. Example Interactive Media Object

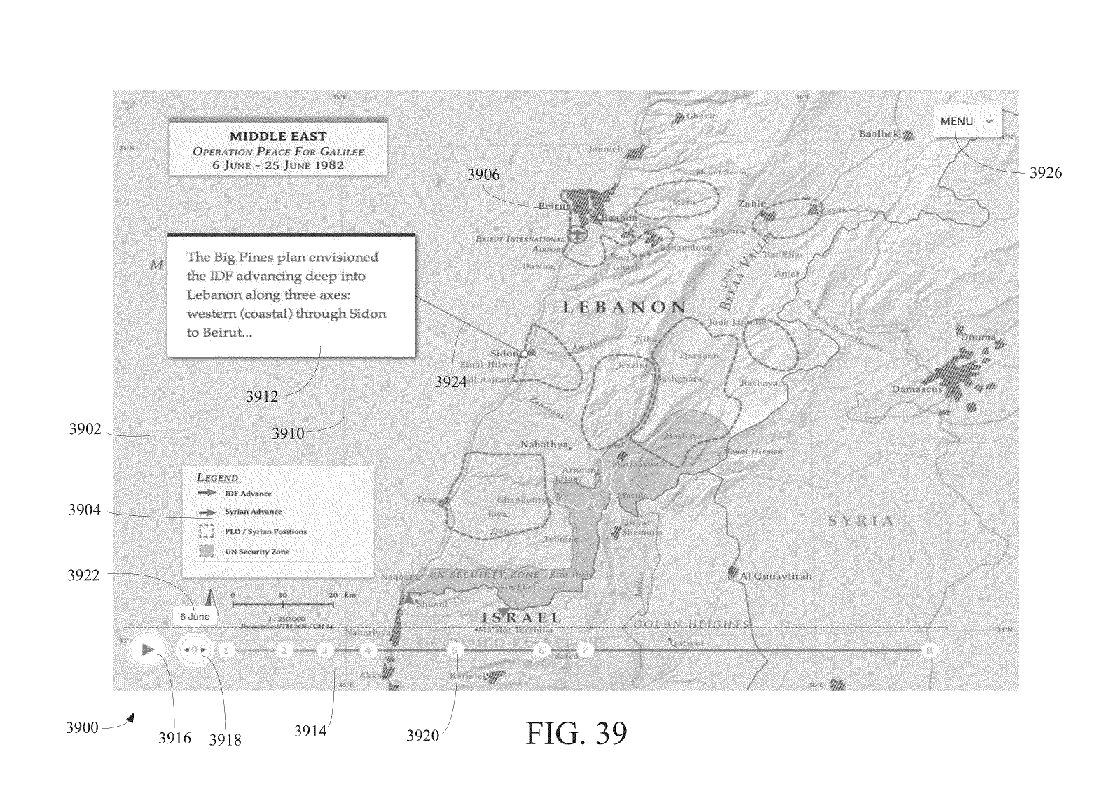

FIG. 39 shows an example interactive media object 3900 in accordance with embodiments described herein. Interactive media object 3900 may have been developed using system 100 or 200, as respectively shown in FIGS. 1 and 2. As shown in FIG. 39, interactive media object 3900 includes a background image 3902, a legend image 3904, a filmstrip 3906, an overlay 3910, a text hotspot 3912, and an animation style control mechanism 3914. Background image 3902 depicts a map of a particular region of the Middle East. Filmstrip 3906 is an animation showing the advances of the Israeli Defense Forces (IDF) and Syrian army, the positions of the Palestinian Liberation Organization (PLO)/Syrian army, and the United Nations (UN) Security Zone over time (i.e., Jun. 6, 1982 to Jun. 25, 1982). Legend image 3904 provides a key for the various features shown via filmstrip 3906.

Filmstrip 3906 is controllable using animation style control mechanism 3914, which includes a play button 3916, a slider 3918, and a plurality of keyframe indicators (e.g., keyframe indicator 3920). A user (e.g., an end-user) activates play button 3916 to begin the animation for filmstrip 3906. The user may also choose a particular frame of filmstrip 3906 using slider 3918. In accordance with an embodiment, the keyframes of filmstrip 3906 may serve as stopping points during playback of filmstrip 3906 if the developer activated interface element 3112 (as described above with respect to FIG. 31) during development of interactive media object 3902. A popover 3922 is also provided above slider 3918 that displays the date associated with the frame of filmstrip 3906 being displayed.

Overlay 3910 provides grid lines for the map depicted by background image 3902. Text hotspot 3912 shows text pertaining to a particular feature of background image 3902 (e.g., the city of Sidon). Text hotspot 3912 also includes a tail 3924 that acts as a pointer to that particular feature.

Overlay 3910 and text hotspot 3912 may be disabled using interactive toggle menu 3926. For example, when expanded, interactive toggle menu 3944 may include toggle switches (as described above with respect to FIGS. 18 and 23) that cause each of overlay 3910 and text hotspot 3912 to be displayed or not displayed.

### VI. Example Computer System Implementations

Any of the components of system 100, as described above in reference to FIG. 1, any of the components of system 200, as described above in reference to FIG. 2, any of the components of interactive media object development engine 302, as described above in reference to FIG. 3, any of the GUI screens (or portions thereof) shown in FIGS. 4-35 and 37, any of the components of filmstrip module 3600, as shown in FIG. 36, any of all of the steps of flowchart 3800 depicted in FIG. 38, and/or any further systems, sub-systems, and/or components disclosed herein may be implemented in hardware, or any combination of hardware with software and/or firmware. For example, any of the components of system 100, any of the components of system 200, any of the components of interactive media object development engine 302, any of the GUI screens (or portions thereof) shown in FIGS. 4-35 and 37, any of the components of filmstrip module 3600, and/or any of all of the steps of flowchart 3800 depicted in FIG. 38 may be implemented as computer program code configured to be executed in one or more processors. Alternatively, any of the components of system 100, any of the components of system 200, any of the components of interactive media object development engine 302, any of the GUI screens (or portions thereof) shown in FIGS. 4-35 and 37, any of the components of filmstrip module 3600, and/or any of all of the steps of flowchart 3800 depicted in FIG. 38 may be implemented as hardware logic/electrical circuitry.

As described above, browser and/or interactive media object development engines may generate one or more user interfaces. For instance, browsers and interactive media object development engines may enable user input to be provided from one or more of any types of user interface elements provided by a computing device, including a keyboard, a thumb wheel, a pointing device, a roller ball, a stick pointer, a touch sensitive display, any number of virtual interface elements, a voice recognition system, etc. GUIs may be displayed in a display of the computing device, such as in a browser window generated by a web browser, an application window, or in other window type mentioned elsewhere herein or otherwise known.

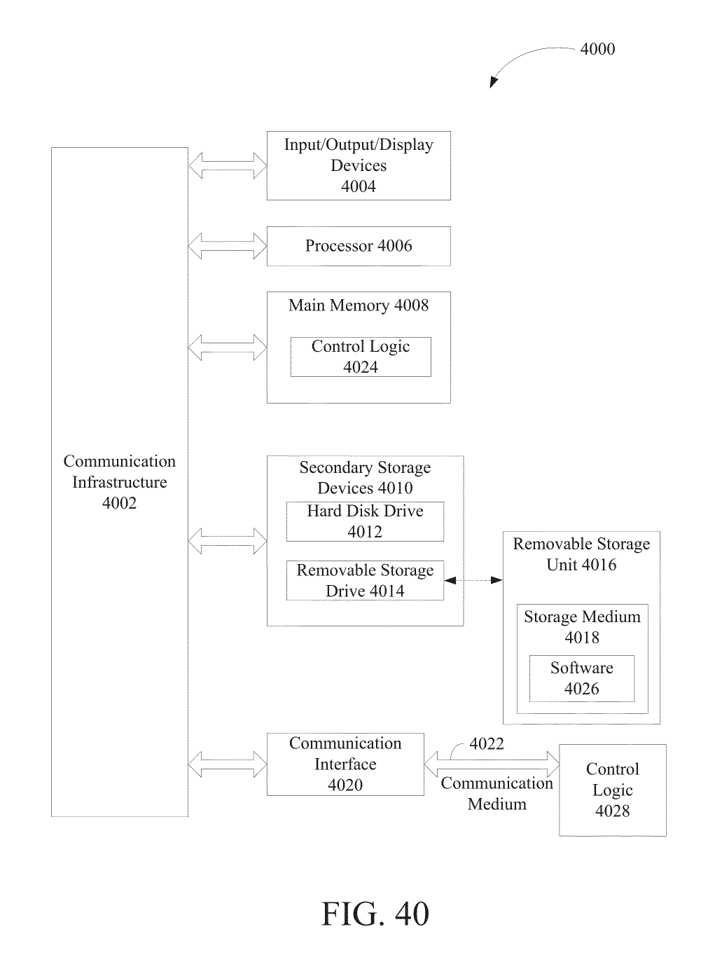

The embodiments described herein, including systems, methods/processes, and/or apparatuses, may be implemented using well known servers/computers, such as a computer 4000 shown in FIG. 40. For example, any of the components of system 100, any of the components of system 200, any of the components of interactive media object development engine 302, any of the GUI screens (or portions thereof) shown in FIGS. 4-35 and 37, any of the components of filmstrip module 3600, and/or any of all of the steps of flowchart 3800 depicted in FIG. 38 may be implemented using one or more computers 4000.

Computer 4000 can be any commercially available and well known computer capable of performing the functions described herein, such as computers available from International Business Machines, Apple, Sun, HP, Dell, Cray, etc. Computer 4000 may be any type of computer, including a desktop computer, a server, etc.

Computer 4000 includes one or more processors (also called central processing units, or CPUs), such as a processor 4006. Processor 4006 is connected to a communication infrastructure 4002, such as a communication bus. In some embodiments, processor 4006 can simultaneously operate multiple computing threads.

Computer 4000 also includes a primary or main memory 4008, such as random access memory (RAM). Main memory 4008 has stored therein control logic 4024 (computer software), and data.

Computer 4000 also includes one or more secondary storage devices 4010. Secondary storage devices 4010 include, for example, a hard disk drive 4012 and/or a removable storage device or drive 4014, as well as other types of storage devices, such as memory cards and memory sticks. For instance, computer 4000 may include an industry standard interface, such a universal serial bus (USB) interface for interfacing with devices such as a memory stick. Removable storage drive 4014 represents a floppy disk drive, a magnetic tape drive, a compact disk drive, an optical storage device, tape backup, etc.

Removable storage drive 4014 interacts with a removable storage unit 4016. Removable storage unit 4016 includes a computer useable or readable storage medium 4018 having stored therein computer software 4026 (control logic) and/or data. Removable storage unit 4016 represents a floppy disk, magnetic tape, compact disk, DVD, optical storage disk, or any other computer data storage device. Removable storage drive 4014 reads from and/or writes to removable storage unit 4016 in a well-known manner.

Computer 4000 also includes input/output/display devices 4004, such as monitors, keyboards, pointing devices, etc.

Computer 4000 further includes a communication or network interface 4018. Communication interface 4020 enables computer 4000 to communicate with remote devices. For example, communication interface 4020 allows computer 4000 to communicate over communication networks or mediums 4022 (representing a form of a computer useable or readable medium), such as LANs, WANs, the Internet, etc. Network interface 4020 may interface with remote sites or networks via wired or wireless connections.

Control logic 4028 may be transmitted to and from computer 800 via the communication medium 4022.

Any apparatus or manufacture comprising a computer useable or readable medium having control logic (software) stored therein is referred to herein as a computer program product or program storage device. This includes, but is not limited to, computer 4000, main memory 4008, secondary storage devices 4010, and removable storage unit 4016. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing any of the components of system 100, any of the components of system 200, any of the components of interactive media object development engine 302, any of the GUI screens (or portions thereof) shown in FIGS. 4-35 and 37, any of the components of filmstrip module 3600, any of all of the steps of flowchart 3800 depicted in FIG. 38, and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### VII. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for enabling a user to develop an interactive media object suitable for display on a computing device, comprising:
providing a graphical user interface by which the user can select a background image and one or more interactive components for insertion over the background image, the one or more interactive components including at least one of:
a hotspot that causes multimedia content to be displayed over the background image when activated,
an overlay component that causes an image to be displayed over the background image when activated and causes the image to be hidden when deactivated,
a foreground image that is displayed over the background image, and
a filmstrip that is displayed over the background image and that comprises a set of images that compose an animation when played back; and
providing a bundler that assembles the background image and the one or more interactive components into the interactive media object.

2. The method of claim 1, wherein the interactive media object comprises an interactive media object suitable for embedding in a digital book.

3. The method of claim 1, wherein the graphical user interface further comprises a hotspot detail editor that enables the user to configure one or more parameters of the hotspot, the one or more parameters comprising:
the multimedia content to be displayed over the background image when the hotspot is activated.

4. The method of claim 1, wherein the graphical user interface further comprises a frame detail editor that enables the user to designate one or more images of the filmstrip as one or more respective keyframes, wherein the one or more respective keyframes serve as stopping points during playback of the filmstrip.

5. The method of claim 1, further comprising providing a filmstrip module that includes at least one of:
a timeline controller module that causes a ticker to be displayed for each of the one or more respective keyframes, the ticker displaying time sensitive information associated with each of the one or more respective keyframes, wherein the timeline controller module further causes data associated with each of the one or more respective keyframes to be displayed as a list, the data comprising at least one of a date and time associated with each of the one or more respective keyframes; and
a controls module that enables the user to select a particular image of the set of images for viewing or configuring.

6. The method of claim 1, further comprising:
providing a zoom module that enables the user to perform a zoom operation on at least a portion of the at least one of the background image, the foreground image and the overlay.

7. The method of claim 1, wherein the graphical user interface further comprises an interface element that, when activated, provides an interactive preview of the interactive media object within the graphical user interface.

8. A system, comprising:
one or more processors; and
a memory that stores computer program logic that, when executed by the one or more processors, enables a user to develop an interactive media object suitable for display on a computing device by performing the steps of:
providing a graphical user interface by which the user can select a background image and one or more interactive components for insertion over the background image, the one or more interactive components including at least one of:
a hotspot that causes multimedia content to be displayed over the background image when activated,
an overlay component that causes an image to be displayed over the background image when activated and causes the image to be hidden when deactivated,
a foreground image that is displayed over the background image, and
a filmstrip that is displayed over the background image and that comprises a set of images that compose an animation when played back; and
providing a bundler that assembles the background image and the one or more interactive components into the interactive media object.

9. The system of claim 8, wherein the interactive media object comprises an interactive media object suitable for embedding in a digital book.

10. The system of claim 8, wherein the graphical user interface further comprises a hotspot detail editor that enables the user to configure one or more parameters of the hotspot, the one or more parameters comprising:
the multimedia content to be displayed over the background image when the hotspot is activated.

11. The system of claim 8, wherein the graphical user interface further comprises a frame detail editor that enables the user to designate one or more images of the filmstrip as one or more respective keyframes, wherein the one or more respective keyframes serve as stopping points during playback of the filmstrip.

12. The system of claim 8, wherein the computer program logic, when executed by the one or more processors further performs the step of:
providing a filmstrip module that includes at least one of:
a timeline controller module that causes a ticker to be displayed for each of the one or more respective keyframes, the ticker displaying time sensitive information associated with each of the one or more respective keyframes, wherein the timeline controller module further causes data associated with each of the one or more respective keyframes to be displayed as a list, the data comprising at least one of a date and time associated with each of the one or more respective keyframes; and
a controls module that enables the user to select a particular image of the set of images for viewing or configuring.

13. The system of claim 8, wherein the computer program logic, when executed by the one or more processors, further performs the step of:
providing a zoom module that enables the user to perform a zoom operation on at least a portion of the at least one of the background image, the foreground image and the overlay.

14. The system of claim 8, wherein the graphical user interface further comprises an interface element that, when activated, provides an interactive preview of the interactive media object within the graphical user interface.

15. A computer program product comprising a computer-readable medium having computer program logic recorded thereon for enabling a processor-based system to enable a user to develop an interactive media object suitable for display on a computing device, the computer program product comprising:
a first program logic module for enabling the processor-based system to provide a graphical user interface by which the user can select a background image and one or more interactive components for insertion over the background image, the one or more interactive components including at least one of:
a hotspot that causes multimedia content to be displayed over the background image when activated,
an overlay component that causes an image to be displayed over the background image when activated and causes the image to be hidden when deactivated,
a foreground image that is displayed over the background image, and
a filmstrip that is displayed over the background image and that comprises a set of images that compose an animation when played back; and
a second program logic module for enabling the processor-based system to provide a bundler that assembles the background image and the one or more interactive components into the interactive media object.

16. The computer program product of claim 15, wherein the interactive media object comprises an interactive media object suitable for embedding in a digital book.

17. The computer program product of claim 15, wherein the graphical user interface further comprises a hotspot detail editor that enables the user to configure one or more parameters of the hotspot, the one or more parameters comprising:
the multimedia content to be displayed over the background image when the hotspot is activated.

18. The computer program product of claim 15, wherein the graphical user interface further comprises a frame detail editor that enables the user to designate one or more images of the filmstrip as one or more respective keyframes, wherein the one or more respective keyframes serve as stopping points during playback of the filmstrip.

19. The computer program product of claim 15, further comprising:
a third program logic module for enabling the processor-based system to provide a filmstrip module that includes at least one of:
a timeline controller module that causes a ticker to be displayed for each of the one or more respective keyframes, the ticker displaying time sensitive information associated with each of the one or more respective keyframes, wherein the timeline controller module further causes data associated with each of the one or more respective keyframes to be displayed as a list, the data comprising at least one of a date and time associated with each of the one or more respective keyframes; and
a controls module that enables the user to select a particular image of the set of images for viewing or configuring.

20. The computer program product of claim 15, further comprising:
a third program logic module for enabling the processor-based system to provide a zoom module that enables the user to perform a zoom operation on at least a portion of the at least one of the background image, the foreground image and the overlay.

21. An apparatus for enabling a user to develop an interactive media object suitable for display on a computing device, comprising:
first means for providing a graphical user interface by which the user can select a background image and one or more interactive components for insertion over the background image, the one or more interactive components including at least one of:
a hotspot that causes multimedia content to be displayed over the background image when activated,
an overlay component that causes an image to be displayed over the background image when activated and causes the image to be hidden when deactivated,
a foreground image that is displayed over the background image, and a filmstrip that is displayed over the background image and that comprises a set of images that compose an animation when played back; and
second means for providing a bundler that assembles the background image and the one or more interactive components into the interactive media object.
